(19) United States
(12) Patent Application Publication
(10) Pub. No.: US 2025/0196117 A1
(43) Pub. Date: Jun. 19, 2025

(54) INORGANIC NANOSHEET COMPOSITE AND METHOD FOR PRODUCING INORGANIC NANOSHEET COMPOSITE

(71) Applicant: Fukuoka Institute of Technology, Fukuoka-shi (JP)

(72) Inventors: Nobuyoshi MIYAMOTO, Fukuoka-shi (JP); Hiroyuki IWANO, Fukuoka-shi (JP)

(73) Assignee: Fukuoka Institute of Technology, Fukuoka-shi (JP)

(21) Appl. No.: 18/979,361

(22) Filed: Dec. 12, 2024

(30) Foreign Application Priority Data
Dec. 15, 2023 (JP) 2023-212160

(51) Int. Cl. B01J 31/38; B01J 21/06; B01J 31/18; B01J 35/39; B01J 35/45; B01J 35/54; B01J 35/58; B01J 37/04; B01J 37/30

(52) U.S. Cl. CPC B01J 31/38; B01J 21/063; B01J 31/1815; B01J 35/39; B01J 35/45; B01J 35/54; B01J 35/58; B01J 37/04; B01J 37/30; B01J 2231/005; B01J 2531/821

(57) ABSTRACT

An inorganic nanosheet composite includes: a plurality of monodisperse inorganic nanosheets; and a cationic species excluding a simple metal ion and an ammonium cation, in which the cationic species is located between the monodisperse inorganic nanosheets in a nanosheet laminated nanofiber in which the plurality of monodisperse inorganic nanosheets are laminated, and an equivalent ratio of the cationic species to an ion exchange capacity of the monodisperse inorganic nanosheet is an equivalent ratio in a range in which the nanosheet laminated nanofiber is formed.

### BACKGROUND

### Technical Field

The present invention relates to an inorganic nanosheet composite and a method for producing an inorganic nanosheet composite. In particular, the present invention relates to an inorganic nanosheet composite including a cationic species and a method for producing an inorganic nanosheet composite.

### Related Art

An inorganic nanosheet laminated structure having a string-like structure including a plurality of laminated inorganic nanosheets has conventionally been known (for example, refer to JP 2022-42584 A). In order to obtain an inorganic nanosheet laminated structure described in JP 2022-42584 A, first, by the bottom-up method, an inorganic nanosheet with substantially homogeneous particle sizes and shapes is obtained from a raw material solution, and then inorganic nanosheets having a pretty narrow particle-size distribution can be obtained. Thereafter, a string-like structure can be formed by applying an attractive force between the inorganic nanosheets by concentration or other methods.

### SUMMARY

In the production of an inorganic nanosheet structure described in JP 2022-42584 A, a predetermined ammonium salt and a predetermined metal alkoxide are mixed to be refluxed, and thereafter a string-like structure of inorganic nanosheets can be formed by concentration or other methods. However, the production of the inorganic nanosheet laminated structure described in JP 2022-42584 A requires a producing method under conditions that are limited to some extent. In addition, for the inorganic nanosheet laminated structure described in JP 2022-42584 A, it is difficult to have characteristics different from those of the inorganic nanosheets forming the inorganic nanosheet structure.

Accordingly, an object of the present invention is to provide an inorganic nanosheet composite that is obtained by a relatively simple method for producing, the inorganic nanosheet composite including a cationic species capable of imparting predetermined characteristics to the inorganic nanosheet composite, and a method for producing an inorganic nanosheet composite.

In order to achieve the above object, the present invention provides an inorganic nanosheet composite including: a plurality of monodisperse inorganic nanosheets; and a cationic species excluding a simple metal ion and an ammonium cation, in which the cationic species is located between the monodisperse inorganic nanosheets in a nanosheet laminated nanofiber in which the plurality of monodisperse inorganic nanosheets are laminated, and an equivalent ratio of the cationic species to an ion exchange capacity of the monodisperse inorganic nanosheet is an equivalent ratio in a range in which the nanosheet laminated nanofiber is formed.

In addition, when the equivalent ratio is a predetermined equivalent ratio or more in the above inorganic nanosheet composite, an aggregate of the nanosheet laminated nanofibers may be included. In addition, in the above inorganic nanosheet composite, the monodisperse inorganic nanosheet may be selected from the group consisting of a layered metal chalcogenide, a layered metal oxide, a layered metal oxyhalide, a layered metal phosphate, a clay mineral or a layered silicate, and a layered double hydroxide, and the cationic species may be selected from the group consisting of a metal complex, a metal cluster ion, a molecular ion, and a polymer electrolyte. Furthermore, the above inorganic nanosheet composite may be an inorganic nanosheet composite for a visible light responsive photocatalyst.

In addition, in order to achieve the above object, the present invention provides a method for producing an inorganic nanosheet composite, the method including: mixing an ammonium salt, a metal alkoxide, and a solvent to prepare a mixed solution; preparing a colloidal solution of monodisperse inorganic nanosheets synthesized by refluxing the mixed solution; and forming an inorganic nanosheet composite by mixing an aqueous solution including a cationic species excluding a simple metal ion and an ammonium cation with the colloidal solution, in which the cationic species is located between the respective monodisperse inorganic nanosheets in a nanosheet laminated nanofiber in which the plurality of monodisperse inorganic nanosheets are laminated, and an equivalent ratio of the cationic species to an ion exchange capacity of the monodisperse inorganic nanosheet is an equivalent ratio in a range in which the nanosheet laminated nanofiber is formed.

With an inorganic nanosheet composite and a method for producing an inorganic nanosheet composite according to the present invention, an inorganic nanosheet composite that is obtained by a relatively simple method for producing and includes a cationic species capable of imparting predetermined characteristics to the inorganic nanosheet composite, and a method for producing an inorganic nanosheet composite can be provided.

### BRIEF DESCRIPTION OF DRAWINGS

FIGS. 1A and 1B are diagrams of visual-observation results of samples according to Experimental Examples 1 to 14;

FIG. 2 is diagrams of the crossed Nicols observations of the samples according to Experimental Examples 1 to 14;

FIGS. 3A and 3B are diagrams of samples in which conventional inorganic nanosheets are uniformly dispersed observed with a polarizing microscope;

FIG. 4 is diagrams of the samples according to Experimental Examples 1 to 14 observed with a polarizing microscope;

FIG. 5 is a diagram of UV-vis measurement of a titania nanosheet with a calibration curve;

FIG. 6 is a diagram of UV-vis measurement of a ruthenium complex aqueous solution with calibration curves;

FIG. 7 illustrates UV-vis measurement of a ruthenium/titania nanosheet composite ([Ru(bpy)₃]²⁺-mNS);

FIGS. 8A to 8D are diagrams of FM observation;

FIG. 9 is diagrams of the samples according to Experimental Examples 1, 6, 7, 8, 9, 10, 13, and 14 observed with a confocal microscope;

FIG. 10 is a diagram of small/wide-angle X-ray scattering measurements on the samples according to Experimental Examples 1 to 14;

FIG. 11 is a conceptual diagram of a ruthenium/titania nanosheet composite ([Ru(bpy)₃]²⁺-mNS);

FIG. 12 is TEM images of the samples according to Experimental Examples 4, 7, and 13;

FIG. 13 is AFM images of the sample according to Experimental Example 2;

FIG. 14 is a schematic diagram of a nanosheet laminated nanofiber;

FIGS. 15A to 15C are diagrams of observation results of a rinsed sample;

FIG. 16 is a diagram of the results of small/wide-angle X-ray scattering measurements of the respective samples in Experimental Example 9;

FIGS. 17A to 17E are diagrams of the results of visual observations and the crossed Nicols observations of inorganic nanosheet composites in which various metal complexes are combined with titania nanosheets (mNSs); and

FIG. 18 is a diagram illustrating the results of the SAXS/WAXS measurements of laminated nanofibers including inorganic nanosheet composites in which various metal complexes are combined with titania nanosheets (mNSs), with the results of Experimental Example 9, in a comparison manner.

### DETAILED DESCRIPTION

### Conventional Knowledge on Inorganic Nanosheet Composite

The conventional method for producing an inorganic nanosheet requires a peeling treatment step such as a step of intercalating a predetermined compound with a layered crystal to peel the layered crystal and a step of peeling the layered crystal by irradiation with ultrasonic waves, and therefore irregular crushing of the layered crystal occurs, failing to substantially uniform the particle size and shape of the inorganic nanosheet. In other words, a part of the inorganic nanosheets is crushed by the peeling treatment step, and the shape and particle size of the inorganic nanosheets are not uniform. In the first place, the shape and particle size cannot be controlled. Therefore, it is impossible to control the expression of a highly ordered structure (for example, a columnar phase or the like) by the conventional method (so-called top-down method). Therefore, conventionally, only a liquid crystal state called a nematic liquid crystal phase or a swollen lamellar phase has been reported. Furthermore, the conventional DLVO theory, Onsager theory, and the like are based on the premise that the object is a stable colloidal system under the control of repulsive force, and are not based on the use of induction of attractive force as in organic thermotropic liquid crystals. That is, conventionally, in the design of liquid crystals using an inorganic material, the viewpoint of attraction induction has been almost ignored. Then, since the particle sizes of inorganic nanosheets obtained by the conventional method are not uniform, it is also impossible to optimize a predetermined function (for example, catalytic activation function) by examination of physical properties using the particle size of an inorganic nanosheet as a parameter or by precise control of the aggregate structure of inorganic nanosheets.

The inventors of the present invention have investigated for the purpose of precisely designing a highly organized structure in an inorganic nanosheet liquid crystal, and has found that extremely narrowing the particle size distribution of inorganic nanosheets, typically, making the particle size and shape of the inorganic nanosheet substantially uniform actually greatly contributes to the formation of the highly organized structure of the inorganic nanosheet liquid crystal. Specifically, the inventors of the present invention have attempted to introduce precise control of the particle size and shape of the inorganic nanosheet and the viewpoint of attractive interaction into the synthesis of inorganic nanosheet liquid crystal, and has proposed the inorganic nanosheet laminated structure (it may be referred to as “inorganic nanosheet laminated column”) having a string-like structure reported in JP 2022-42584 A by the inventors. In this proposal, an inorganic nanosheet is directly synthesized by stirring a solution obtained by mixing a predetermined metal alkoxide and a predetermined organic cation for a certain period of time. Furthermore, in this proposal, it is stated that, by this synthesis method, monodisperse inorganic nanosheets having an extremely narrow particle size distribution and a substantially uniform shape are synthesized, the concentration of the monodisperse inorganic nanosheet and the concentration of a salt to coexist are adjusted, the interaction between the inorganic nanosheets is controlled, and thereby an inorganic nanosheet laminated structure having a string-like structure can be obtained.

Furthermore, in JP 2022-42584 A, by investigating the conditions under which the colloid of the monodisperse inorganic nanosheets obtained by synthesis forms a liquid crystal phase, the inventors of the present invention have proposed that when a monodisperse inorganic nanosheet having a particle size of about 20 nm and a predetermined organic cation coexist, the inorganic nanosheets form an inorganic nanosheet laminated structure including a string-like structure like an organic supramolecular polymer (the formation is easier when both the monodisperse inorganic nanosheet and a predetermined organic cation coexist at a high concentration), and that the inorganic nanosheet laminated structure is oriented to express a columnar nematic liquid crystal phase. This column structure can also be regarded as a layered crystal having an extremely unique shape with a long axis in a direction perpendicular to the laminating plane. Furthermore, it has been proposed that the formation of the inorganic nanosheet laminated structure and liquid crystal is reversible.

### New Knowledge on Inorganic Nanosheet Composite

The inorganic nanosheet laminated structure reported in JP 2022-42584 A requires a step of adjusting the concentration of inorganic nanosheet and an ammonium salt to the concentrations at which the plurality of inorganic nanosheets are laminated. That is, since it is necessary to adjust the concentration condition of the predetermined ammonium salt to a relatively high concentration, it is not easy to maintain the laminated structure without adjusting the salt concentration and to impart predetermined characteristics to the laminated structure, and it is desired to make the method for producing the laminated structure itself easier. The present inventors have focused on the structure itself of an inorganic nanosheet laminated structure and attempted to control the interaction between inorganic nanosheets by a principle different from that due to an ammonium salt. That is, the present inventors have attempted to control the interaction between the inorganic nanosheets with the structure itself of the inorganic nanosheets, without controlling the interaction by causing the ammonium salt to be present around the inorganic nanosheets, in other words, by the salt concentration in the solution of inorganic nanosheets and an ammonium salt. Specifically, the present inventors have found that a predetermined laminated structure (hereinafter, it may be referred to as “nanosheet laminated nanofiber”) that can be stably present, that is, an inorganic nanosheet composite can be synthesized by controlling a binding force between the inorganic nanosheets (that is, between the layers) by using the predetermined cationic species by applying various compounds to the inorganic nanosheets.

That is, the present inventors have found that an inorganic nanosheet composite can be stably synthesized by introducing, between the inorganic nanosheets, a cationic species exerting interaction (attractive force between the inorganic nanosheets) of binding the inorganic nanosheets (that is, the layers) to one another, without controlling the binding by causing the ammonium salt to be present around the inorganic nanosheets. In addition, the present inventors have also found that by changing the equivalent ratio of a cationic species to an ion exchange capacity of the inorganic nanosheet, the nanosheet laminated nanofibers of the inorganic nanosheets and the aggregate of the nanosheet laminated nanofibers can be selectively synthesized.

Specifically, the nanosheet laminated nanofibers are formed by aggregating anionic inorganic nanosheets by the electrostatic interaction with the cationic species. However, in a case where the cationic species is a small simple metal ion such as Na₊, K⁺, or Ca²⁺, since the charge/size ratio of the cationic species is large, the electrostatic interaction is too strong, and the inorganic nanosheets become a random aggregate laminated without being aligned in the lateral direction. In contrast, when an organic cation (ammonium cation) such as an alkylammonium cation and an alkyltrimethylammonium cation is used, the charge/size ratio of the cation becomes small, the horizontal positions of the inorganic nanosheets can be adjusted while the inorganic nanosheets are aggregating by electrostatic interaction not too strong, and thereby nanosheet laminated nanofibers are formed. However, the nanosheet laminated nanofibers formed of such an organic cation are easily dissociated.

From the viewpoint of increasing the degree of freedom in adjusting the cation size and valence, the present inventors have attempted to use cationic species (for example, metal complexes, metal cluster ions, molecular ions, and polyelectrolytes) that have not ever been investigated. As a result, the present inventors have found that, by using these cationic species, it is possible to control the formation of the nanosheet laminated nanofibers and to adjust the stability of the nanosheet laminated nanofibers. Furthermore, since various functions of these cationic species can be introduced into the nanosheet laminated nanofiber, the present inventors have also found that it is possible to design a material having luminescence capability, magnetism, electrical conductivity, oxidation-reduction capability, and/or capability of selectively adsorbing substances. For example, in the experimental examples described later, the nanosheet laminated nanofibers using the ruthenium complex (Ru(bpy)₃²⁺) will be described. However, in the nanosheet laminated nanofibers into which the ruthenium complex has been introduced, it has been confirmed that the nanosheet laminated nanofibers are stably present even when the ionic strength of the solution is reduced to 10⁻². In addition, it has been also confirmed that the fluorescence characteristics of the ruthenium complex were imparted to the nanosheet laminated nanofibers. The present invention is based on these findings.

Here, as a principle by which the inorganic nanosheet composite can be stably synthesized, the following principle is assumed. First, from the viewpoint of strengthening the binding force between the inorganic nanosheets, it is conceivable to introduce a predetermined metal ion between the inorganic nanosheets. However, when a simple metal ion (for example, a metal ion, such as Ca²⁺ or the like, having no ligand) is used, the binding force between the inorganic nanosheets becomes too strong, and it is not possible to synthesize appropriate nanosheet laminated nanofibers as described above. The present inventors have investigated from the viewpoint of stable synthesis of nanosheet laminated nanofibers, and has found that the binding force between the inorganic nanosheets can be adjusted in a range in which the nanosheet laminated nanofibers can stably be present by using cationic species having a ligand or the like exerting steric hindrance more than a simple metal ion does from the viewpoint of achieving a binding force to the extent of forming an inorganic nanosheet composite, while the binding force between the inorganic nanosheets is made smaller than that with metal ions. That is, the following principles are assumed.

### a) Control of Interaction Between Monodisperse Inorganic Nanosheets by Cationic Species

The interaction of binding monodisperse inorganic nanosheets to one another caused by a predetermined cationic species is weaker than the interaction of binding monodisperse inorganic nanosheets to one another caused by a simple metal ion. Therefore, when the predetermined cationic species is used, random aggregation of monodisperse inorganic nanosheets is restrained, and nanosheet laminated nanofibers are obtained.

b) Increasing Stability of Inorganic Nanosheet Composite with Cationic Species

The interaction of binding the monodisperse inorganic nanosheets to one another caused by the predetermined cationic species is stronger than the interaction of binding the monodisperse inorganic nanosheets to one another caused by an alkyl ammonium ion (for example, tetrabutylammonium or the like) that has been used conventionally. Therefore, nanosheet laminated fibers that are hardly decomposed and are highly stable can be formed.

### c) Control of Interaction Between Monodisperse Inorganic Nanosheets by Equivalent Ratio

By changing the equivalent ratio of a cationic species to an ion exchange capacity of the monodisperse inorganic nanosheet, the aforementioned interaction can be controlled. As a result, the higher-order structure of a monodisperse inorganic nanosheet can be selectively formed.

d) Control of Formation of Nanosheet Laminated Nanofibers with Valence or the Like

By the valence and the size of the ligand of a central metal when the cationic species is a metal complex, by the valence and the cation size when the cationic species is a molecular ion or a metal cluster ion, or by the degree of polymerization and the introduced amount of cationic monomer when the cationic species is a polymer electrolyte (polymer cation), the attractive force between a monodisperse inorganic nanosheet and a cationic species can be precisely controlled, and thereby nanosheet laminated fibers can be formed. The metal complex, the molecular ion, the metal cluster ion, and the polymer electrolyte are publicly known compound, and the valence and the size of the ligand of the central metal of the metal complex, the valence and the cation size of each of the molecular ion and the metal cluster ion, and the degree of polymerization and the introduced amount of cationic monomer of the polymer electrolyte are also publicly known. Therefore, it is possible to estimate, from the publicly known information, the attractive force between the monodisperse inorganic nanosheet and the cationic species in a range in which the nanosheet laminated nanofibers can be formed.

By combining the above four principles and applying the predetermined cationic species to the monodisperse inorganic nanosheets, it is possible to form nanosheet laminated nanofibers in which the cationic species is located between the monodisperse inorganic nanosheets (between layers) and an aggregate of the nanosheet laminated nanofibers (hereinafter, it may be referred to as “nanosheet laminated nanofiber aggregate”).

The present invention has been made based on the above-mentioned findings and the assumed principles. Hereinafter, the inorganic nanosheet composite according to the present embodiment will be described in detail.

### Details of Inorganic Nanosheet Composite

In the present embodiment, the predetermined cationic species is located between the monodisperse inorganic nanosheets, and the equivalent ratio of the cationic species to the ion exchange capacity of the monodisperse inorganic nanosheet is controlled, whereby the nanosheet laminated nanofiber having a string-like shape in which the monodisperse inorganic nanosheets are laminated is formed. The nanosheet laminated nanofiber is one of the inorganic nanosheet composites. In addition, by controlling the equivalent ratio of the cationic species to the ion exchange capacity of the monodisperse inorganic nanosheet, the nanosheet laminated nanofibers and the aggregate of the nanosheet laminated nanofibers in which the nanosheet laminated nanofibers aggregate (this aggregate is also one of the inorganic nanosheet composites) can be selectively formed. That is, the inorganic nanosheet composite according to the present embodiment is nanosheet laminated nanofibers and/or the aggregate of the nanosheet laminated nanofibers, the nanosheet laminated nanofibers having a string-like shape and composed of a plurality of monodisperse inorganic nanosheets laminated at predetermined intervals and the cationic species located between the monodisperse inorganic nanosheets.

### <Inorganic Nanosheet>

The monodisperse inorganic nanosheet according to the present embodiment is a thin sheet-shaped inorganic crystal as a unit structure obtained by synthesis using a predetermined compound (hereinafter, “monodisperse inorganic nanosheet” may be simply referred to as “inorganic nanosheet” to simplify explanation). For example, the monodisperse inorganic nanosheet is an anionic inorganic nanosheet obtained by reacting a predetermined ammonium salt with a predetermined metal alkoxide. The composition and shape of the inorganic nanosheet are determined according to the type and mixing ratio of the ammonium salt and the metal alkoxide used for the synthesis. In addition, the particle size distribution of the inorganic nanosheets can be adjusted similarly. That is, the shape and thickness of the inorganic nanosheet reflect the crystallographic structure of the inorganic compound to be subjected to the synthesis.

The inorganic nanosheet obtained by the synthesis has, for example, a thickness of several nm (for example, in the case of a lepidocrocite type titanic acid nanosheet, the thickness is 0.75 nm) and a width of about tens of nm to several tens of nm. As a result, the inorganic nanosheet has a shape with large anisotropy (that is, a shape having a high aspect ratio). Herein, the “particle size” of the inorganic nanosheet according to the present embodiment is defined as follows.

The “particle size” of the inorganic nanosheet is substantially a lateral width of the inorganic nanosheet. That is, when the maximum width of the inorganic nanosheet in plan view is defined as a lateral width w, the average value of the lateral width w is defined as the “particle size” in the present embodiment. However, in the present embodiment, the inorganic nanosheet is obtained by synthesis, and therefore the shape of the inorganic nanosheet is reflected from the crystallographic structure of the inorganic compound to be subjected to the synthesis to become a substantially uniform predetermined shape (for example, a rectangular shape or a rhombus shape). In this case, the “particle size” of the inorganic nanosheet is the lateral width of the predetermined shape. For example, when the shape of the inorganic nanosheet is a rectangle, the lateral width can be represented by a combination of the length of the short side and the length of the long side (alternatively, the lengths of the diagonal lines), and when the shape is a rhombus, the lateral width can be represented by a combination of the length of the long axis and the length of the short axis. The “particle size” of the inorganic nanosheet can be measured and calculated by using, for example, a measuring means such as a dynamic light scattering method or an electron microscope. In addition, a thickness t of the inorganic nanosheet is determined depending on the crystal structure of the inorganic material to be synthesized. The thickness of the inorganic nanosheet can be measured by atomic force microscope observation or small-angle X-ray scattering measurement.

In addition, the particle size of the inorganic nanosheet according to the present embodiment is not limited. However, from the viewpoint of highly organizing the inorganic nanosheet, substantial monodisperse is preferable.

Herein, “monodisperse” of the inorganic nanosheet in the present embodiment means that the following conditions are satisfied.

(1) The particle shape observed with a transmission electron microscope is substantially uniform (for example, when the shape of the inorganic nanosheets observed with a transmission electron microscope is a rhombus, the ratio of the short axis to the long axis of the rhombus of each of the inorganic nanosheets observed is 1.4:1, and the lateral widths of the inorganic nanosheets are substantially the same, it can be determined that the shapes are substantially uniform).

(2) A particle size distribution measured by a transmission electron microscope or the like is approximated by a normal distribution function with a single peak, and a standard deviation thereof is less than 50% and approximately 40% or less of the average particle size (when this condition is satisfied, the particle size distribution can be recognized to be extremely narrow).

In the case of the inorganic nanosheets obtained by the conventional peeling method, the particle shape is amorphous, and the standard deviation of the particle size is about 50 to 200% of the average particle size, which can be clearly distinguished from the “monodisperse” inorganic nanosheets in the present embodiment. In addition, by setting the particle size distribution of the inorganic nanosheets to a predetermined narrow distribution, formation of the ordered structure of the inorganic nanosheet in a higher order can be controlled (that is, lower-order control is performed for ordered structure control in a higher order). By making the inorganic nanosheets monodispersive and then controlling the interaction (that is, an attractive force and a repulsive force) between the inorganic nanosheets by adjusting the equivalent ratio of the cationic species to the ion exchange capacity of the inorganic nanosheet within a predetermined range, it is possible to form nanosheet laminated nanofibers and an aggregate of the nanosheet laminated nanofibers. When the repulsive force between the inorganic nanosheets is too strong, the inorganic nanosheets are dispersed and a structure is not formed, and when the attractive force is too strong, the inorganic nanosheets are disorderly and irreversibly aggregated.

These situations can be easily observed by using a polarizing microscope or the like. Even if the attractive force and the repulsive force between the inorganic nanosheets are different depending on the substance species or the size of the inorganic nanosheets, the attractive force and the repulsive force of various inorganic nanosheets can be adjusted by adjusting the equivalent ratio of the cationic species to the ion exchange capacity of the inorganic nanosheet within a predetermined range.

In addition, in the present description, “substantially uniform” does not mean that the particle sizes and shapes of the inorganic nanosheets literally completely coincide with each other in every inorganic nanosheet, but means that in a case where the inorganic nanosheets having different particle sizes and shapes are partially present, the standard deviation of the particle size distribution is within a predetermined value, and by exhibiting a predetermined liquid crystal state or the like in a solution or colloid state, it is recognized that the inorganic nanosheets are in a state where the particle sizes and shapes are uniform in content and essence. In addition, “substantially monodisperse” has the same meaning.

The inorganic nanosheet is not particularly limited as long as it is an inorganic nanosheet obtained by synthesis. That is, there is no particular limitation as long as the inorganic nanosheet can constitute the layered inorganic compound and can be synthesized. Examples of the layered inorganic compound include layered metal chalcogenides, layered metal oxides (for example, titanium oxide, a layered perovskite compound, titanium niobate, and molybdate), layered metal oxyhalides, layered metal phosphates (for example, layered antimony phosphate), clay minerals or layered silicates (for example, mica, smectite group (montmorillonite, saponite, hectorite, fluorohectorite, and the like), kaolin group (kaolinite and the like), magadiite, and kanemite), and layered double hydroxides. Examples of the inorganic nanosheets include various oxide-based nanosheets such as silica nanosheets, titanium oxide nanosheets, niobium oxide nanosheets, and cobalt oxide nanosheets.

In the present embodiment, for example, a layered titanate can be synthesized and used. Examples of the layered titanate include lepidocrocite type layered titanate (for example, CsₓTi_{2-x/4}O₄ (where 0.5≤x≤1), AₓTi₂₋ₓ/3Li_{x/3}O₄ (where A=K, Rb, Cs, 0.5≤x≤1)), which is a crystal having a layered structure formed by a chain of TiO₆ octahedron and having metal ions between layers thereof. Specific examples of the lepidocrocite type layered titanate include K_{0.8}Ti_{1.73}Li_{0.27}O₄, Rb_{0.75}Ti_{1.75}Li_{0.25}O₄, Cs_{0.7}Ti_{1.77}Li_{0.23}O₄, and Cs_{0.7}Ti_{1.825}O₄.

### <Synthesis of Monodisperse Inorganic Nanosheets>

Examples of the method for synthesizing the monodisperse inorganic nanosheets include, for example, a method obtained by improving the previously reported synthesis method based on the previous report (E. L. Tae, et al., J. Am. Chem. Soc., 2008, 130, 6534). As an example, from the viewpoint of easy control of the particle size and shape of the inorganic nanosheets, a method of stirring or refluxing a mixed solution obtained by mixing raw materials in a predetermined solvent can be used. Specifically, a mixed solution obtained by adding a metal alkoxide to an alkali solution or a mixed solution obtained by adding a predetermined ammonium salt and a predetermined metal alkoxide to a predetermined solvent (for example, water) is prepared, and the mixed solution is stirred and/or refluxed to allow synthesis of a colloid (hereinafter, referred to as “monodisperse inorganic nanosheet colloid”) containing monodisperse inorganic nanosheets. The particle size and the shape can be precisely controlled by synthesizing the inorganic nanosheets using the mixed solution as in the present embodiment, and thus monodisperse inorganic nanosheets having a desired particle size and shape can be synthesized.

The concentration of the inorganic nanosheet in the monodisperse inorganic nanosheet colloid can be adjusted depending on the amount of each of the plurality of raw materials (for example, ammonium salts and metal alkoxides) to be mixed with the solvent and/or the ratio of the plurality of raw materials (for example, the ratio of the amount of metal alkoxide to the amount of ammonium salt), for example.

As an example, a monodisperse inorganic nanosheet colloid with a lepidocrocite type layered titanate can be prepared by reacting a metal alkoxide with an ammonium salt and refluxing at a predetermined temperature for a predetermined time. As a result, the inorganic nanosheets that are substantially monodispersive are formed in the colloid.

### (Ammonium Salt)

An alkyl ammonium salt can be used as the ammonium salt. For example, a quaternary ammonium compound can be used as the alkyl ammonium salt. Examples of the quaternary ammonium compound include tetramethylammonium hydroxide (TMAOH), tetraethylammonium hydroxide (TEAOH), tetrapropylammonium hydroxide (TPAOH), tetrabutylammonium hydroxide (TBAOH), and trimethyl-2-hydroxyethylammonium hydroxide.

Herein, the alkyl ammonium salt can be used as a solution added to a predetermined solvent. For example, an aqueous solution of an alkyl ammonium salt can be used. In this case, the concentration of the alkyl ammonium salt in the aqueous solution of an alkyl ammonium salt is not particularly limited as long as it is a concentration at which monodisperse inorganic nanosheets can be synthesized, and for example, from the viewpoint of easily synthesizing monodisperse inorganic nanosheets, the concentration is preferably 0.1 M or more, also preferably 0.3 M or more, and may be 2 M or less.

### (Metal Alkoxide)

Examples of the metal alkoxide include a metal alkoxide represented by the following general formula (1).

M(OR)₄ General Formula (1)

In the general formula (1), M represents a metal element, and R represents the same type or different types of alkyl groups having 1 or more and 10 or less carbon atoms. M is, for example, an element selected from the group consisting of Mg, Al, Si, Ca, V, Cr, Mn, Fe, Co, Ni, Zn, Ga, Ge, Sr, Zr, Nb, Mo, Ru, Rh, Pd, Ag, Cd, In, Sn, Sb, Ba, Ta, W, Re, Os, Ir, Pb, La, Ce, Nd, Sm, Eu, Gd, Tb, and Dy. In addition, R is preferably an alkyl group having 1 to 4 carbon atoms from the viewpoint of achieving an appropriate reaction rate, and is preferably, for example, a methyl group, an ethyl group, a propyl group, an isopropyl group, an n-propyl group, an n-butyl group, a sec-butyl group, an isobutyl group, and a ter-butyl group.

Specific examples of the metal alkoxide include aluminum triethoxide, aluminum triisopropoxide, aluminum tributoxide, aluminum tri-sec-butoxide, aluminum diisopropoxy sec-butoxide, aluminum diisopropoxy acetylacetonate, aluminum di sec-butoxy acetylacetonate, aluminum diisopropoxyethylacetoacetate, aluminum di(sec-butoxyethylacetoacetate), aluminum trisacetylacetonate, aluminum trisethylacetoacetate, aluminum acetylacetonate bisethylacetoacetate, titanium tetraethoxide, titanium tetraisopropoxide, titanium tetrabutoxide, titanium diisopropoxybisacetylacetonate, titanium diisopropoxybisethylacetoacetate, titanium tetra-2-ethylhexyl oxide, titanium diisopropoxybis(2-ethyl-1,3-hexanediolate), titanium dibutoxy bis(triethanolaminate), zirconium tetrabutoxide, zirconium tetraisopropoxide, zirconium tetramethoxide, zirconium tributoxide monoacetylacetonate, zirconium dibutoxide bisacetylacetonate, zirconium butoxide trisacetylacetonate, zirconium tetraacetylacetonate, zirconium tributoxide monoethylacetoacetate, zirconium dibutoxide bisethylacetoacetate, zirconium butoxide trisethylacetoacetate, and zirconium tetraethylacetoacetate. Other examples thereof include cyclic 1,3,5-triisopropoxycyclotrialuminoxane.

In the synthesis of the monodisperse inorganic nanosheets, the pH is mainly set in a range suitable for synthesis by setting the alkylammonium concentration to a certain range. Then, depending on the concentration of the metal alkoxide, the number of nucleations at the initial stage of synthesis of the inorganic nanosheets and the particle size thereafter are determined. For example, in the synthesis of the monodisperse inorganic nanosheets according to the present embodiment, when the alkylammonium concentration is 0.3 M, the reaction is performed at a metal alkoxide concentration of preferably 0.1 M or more, more preferably 0.2 moles or more, and preferably 1 M or less. The average particle size of the obtained inorganic nanosheets can be controlled by adjusting the amount of the metal alkoxide relative to the unit amount of the ammonium salt during synthesis of the monodisperse inorganic nanosheets.

### (Stirring or Refluxing Conditions)

The stirring or refluxing conditions are not particularly limited. The stirring condition may be, for example, a condition of stirring in air (that is, under the air atmosphere) at room temperature (for example, 25° C.) for a predetermined time. In addition, the refluxing condition may be, for example, a condition of refluxing at a temperature exceeding room temperature (as an example, a predetermined temperature of 40° C. or more or 70° C. or more and 100° C. or less) for a predetermined time under the air atmosphere. The average particle size of the inorganic nanosheets can be controlled by the refluxing time. That is, the average particle size of the inorganic nanosheets can be increased as the refluxing time is longer.

### (Solvent)

An aqueous solvent, for example, pure water can be used as the solvent.

### <Cationic Species>

The cationic species according to the present embodiment is not particularly limited as long as it can be introduced between the inorganic nanosheets, has interaction between the inorganic nanosheets weaker than that of a simple metal ion (and/or has interaction between the inorganic nanosheets stronger than that of an alkylammonium ion), and can form the nanosheet laminated nanofibers. Examples of the cationic species include a cationic species excluding a simple metal ion and ammonium cations such as an alkylammonium cation and an alkyltrimethylammonium cation, for example, a metal complex, a metal cluster ion, a molecular ion, and a polymer electrolyte (polymer cations).

### (Metal Complex)

The metal complex is a compound in which a predetermined ligand coordinates to the central metal. In the present embodiment, the interaction of binding the inorganic nanosheets caused by the metal complex is weaker than the interaction of binding the inorganic nanosheets by the simple metal ion of the central metal, and various metal complexes can be used as long as the inorganic nanosheet composite (the nanosheet laminated nanofibers and the nanosheet laminated nanofiber aggregate) can be stably formed. That is, a metal complex that can be used as the metal complex has the ratio (valence/size) of the valence of the central metal to the size of the ligand in a range in which the nanosheet laminated nanofiber can be formed.

For instance, examples of the metal complex include a metal complex formed of: one or more kinds of metals selected from the group consisting of Fe, Co, Ni, Mn, Zn, Cu, W, Ru, Pd, Pt, Ir, Rh, Os, Sm, Sc, Se, Re, Au, and Ag; and one or more kinds of ligands selected from the group consisting of a monodentate ligand, such as aqua (OH₂), hydroxo (OH), hydride (H), chloro (Cl), carbonyl (CO), carboxyl (COOH), pyridine (py), 4-picoline (pic), isoquinoline (isoq), pentamethylcyclopentadienyl (Cp*), and derivatives thereof and a multidentate ligand, such as 2,2′-bipyridine (bpy), 2-phenylpyridine (ppy), 1,10-phenanthroline (phen), pyridine-2-thiolate (pyS), 1,2-benzenedithiolate (bdt), 2,2′: 6′, 2″-terpyridine (tpy), 2,6-bis(1-methylbenzimidazole-2-yl) pyridine (Mebimpy), 2,6-bis(di-tert-butylphosphinomethyl)pyridine (PNPtBu), 1,4,8,11-tetraazacyclotetradecane (cyclam), and porphyrin (por), and derivatives thereof.

As an example, a ruthenium complex, an iron complex, and the like can be used as the metal complex, and examples of the ruthenium complex include a tris(2,2′-bipyridine) ruthenium (II) complex ([Ru(bpy)₃]²⁺), and examples of the iron complex include a tris(2,2′-bipyridine) iron (II) complex ([Fe(bpy)₃]²⁺).

### (Metal Cluster Ion)

The metal cluster ion is an ion of an aggregate of several to several hundred or several thousand metal atoms. In the present embodiment, the interaction of binding the inorganic nanosheets caused by the metal cluster ion is weaker than the interaction of binding the inorganic nanosheets by the simple metal ion, and various metal cluster ions can be used as long as the inorganic nanosheet composite can be stably formed. That is, a metal cluster ion that can be used as the metal cluster ion has the ratio (valence/size) of the valence to the cation size in a range in which the nanosheet laminated nanofiber can be formed.

For example, examples of the metal cluster ion include a metal cluster cation having the Keggin structure. As an example, examples of the Keggin-type cluster cation include a Keggin-type Al cluster cation [ε-Al₁₃O₄(OH)₂₄(H₂O)₁₂]⁷⁺.

### (Molecular Ion)

As the cationic species, the molecular ion can also be used. In the present embodiment, the interaction of binding the inorganic nanosheets caused by the molecular ion is weaker than the interaction of binding the inorganic nanosheets by the simple metal ion, and various molecular ions can be used as long as the inorganic nanosheet composite can be stably formed. That is, a molecular ion that can be used as the molecular ion has the ratio (valence/size) of the valence to the cation size in a range in which the nanosheet laminated nanofiber can be formed.

### Examples of the Molecular Ion Include

[Cr₃O(OOCH)₆(H₂O)₃]⁺.

### (Polymer Electrolyte)

As the cationic species, the polymer electrolyte can also be used. In the present embodiment, the interaction of binding the inorganic nanosheets caused by the polymer electrolyte is weaker than the interaction of binding the inorganic nanosheets by the simple metal ion, and various polymer electrolytes can be used as long as the inorganic nanosheet composite can be stably formed. That is, a polymer electrolyte that can be used as the polymer electrolyte has the degree of polymerization and the introduced amount of cationic monomer in a range in which the nanosheet laminated nanofiber can be formed.

Examples of the polymer cation include various polymers in consideration of interaction with an anionic inorganic nanosheet. Examples of the polymer cation include chitosan, polyallylamine, and polydiallyldimethylammonium, which are cationic polymer cations.

### <Inorganic Nanosheet Composite>

The inorganic nanosheet composite according to the present embodiment includes a plurality of monodisperse inorganic nanosheets and a cationic species (note that a simple metal ion and an ammonium cation are excluded). Specifically, the inorganic nanosheet composite includes the cationic species located between the plurality of monodisperse inorganic nanosheets. That is, in the inorganic nanosheet composite, the cationic species is located between the monodisperse inorganic nanosheets in the nanosheet laminated nanofibers in which the plurality of monodisperse inorganic nanosheets are laminated. Then, the ratio of the equivalent amount (gram equivalent, that is, molecular weight/valence) of the cationic species to the ion exchange capacity (cation exchange capacity (CEC)) of the monodisperse inorganic nanosheets (that is, (equivalent of cationic species)/CEC) is adjusted to be a range in which the nanosheet laminated nanofibers are formed. When the equivalent ratio is a predetermined equivalent ratio or more, the aggregate of the nanosheet laminated nanofibers is formed. That is, the nanosheet laminated nanofibers are formed in a range of a first equivalent ratio, and the nanosheet laminated nanofibers and a laminate of the nanosheet laminated nanofibers are formed in a range of a second equivalent ratio different from the first equivalent ratio. Therefore, by changing the equivalent ratio, the structure of the inorganic nanosheet composite can be changed between the nanosheet laminated nanofibers and the aggregate of the nanosheet laminated nanofibers.

Here, the nanosheet laminated nanofiber according to the present embodiment exerts a string-like structure. Specifically, the nanosheet laminated nanofibers are formed by making the surfaces of the monodisperse inorganic nanosheets (inorganic nanosheets having a substantially uniform particle shape) parallel to the short axis to laminate the inorganic nanosheets in the long axis direction of the nanofibers. Such a string-like structure is formed by self-organization of the inorganic nanosheets having a substantially uniform particle shape during which the surfaces of the inorganic nanosheets are laminated to be parallel to the short axis of the string (the laminated structure can be confirmed in, for example, an image taken with a transmission electron microscope). Then, since the particle shape of the inorganic nanosheet is substantially uniform, the width of the short axis of the string-like structure becomes substantially uniform.

As the cationic species, the above-described various cationic species can be used. The properties of each cationic species, that is, the valence of the central metal and the size of the ligand in the case of a metal complex, the valence and the size of the cation in the case of a molecular ion or a metal cluster ion, and the degree of polymerization and the introduced amount of the cation monomer in the case of a polymer electrolyte are known. Therefore, for example, as stated in the examples described later, the inorganic nanosheet composite according to the present embodiment is formed using a predetermined cationic species having a definite valence, ligand size, and the like, and the attractive force between the monodisperse inorganic nanosheet and the cationic species can be precisely controlled. Therefore, it is possible to estimate how much the predetermined cationic species is used for the predetermined monodisperse inorganic nanosheets to form the inorganic nanosheet composite.

### <Method for Producing Inorganic Nanosheet Composite>

A method for preparing the inorganic nanosheet composite is not particularly limited. For example, a mixed solution (first mixed solution) is prepared by adding a predetermined alkyl ammonium salt and a predetermined metal alkoxide to a predetermined solvent, and the first mixed solution is refluxed to synthesize a monodisperse inorganic nanosheet colloidal solution. Then, the concentration of the inorganic nanosheet in the monodisperse inorganic nanosheet colloidal solution that has been synthesized is adjusted to a predetermined concentration. A predetermined cationic species is added to a predetermined solvent (for example, pure water or the like) to prepare a cationic species solution the concentration of which is adjusted to a predetermined concentration. Then, a mixed solution (second mixed solution) obtained by mixing the monodisperse inorganic nanosheet colloidal solution with the adjusted concentration and the cationic species solution with the adjusted concentration is stirred. After stirring, the second mixed solution is subjected to a desalting treatment to remove an excessive ammonium salt and the like. The stirring condition is not particularly limited. The stirring condition may be, for example, a condition of stirring in air (that is, under the air atmosphere) at room temperature (for example, 25° C.) for a predetermined time.

As a result, the inorganic nanosheet composite according to the present embodiment, that is, the nanosheet laminated nanofiber is obtained. Here, by adjusting the equivalent ratio of the cationic species to the ion exchange capacity of the inorganic nanosheet of the inorganic nanosheet composite to a range of a predetermined equivalent ratio when the second mixed solution is prepared, it is possible to selectively prepare the nanosheet laminated nanofibers or the aggregate of the nanosheet laminated nanofibers.

As the desalting treatment, a method of centrifuging the second mixed solution using a centrifuge can be used. As the desalting treatment, a method of repeating the following steps: the second mixed solution is left to stand for phase separation into a precipitate and a supernatant liquid; the supernatant liquid is removed and then water is added to the precipitate; the mixture is stirred and then left to stand again; and after phase separation, removing the supernatant liquid can also be used. The inorganic nanosheet composite according to the present embodiment can stably maintain the shape even when subjected to the desalting treatment. That is, even when the nanosheet laminated nanofiber as the inorganic nanosheet composite according to the present embodiment is subjected to the desalting treatment, the shape of the nanofiber is stably maintained. This is because the cationic species according to the present embodiment is less soluble in an aqueous solvent than the simple metal ion or the ammonium cation is, and can easily maintain the interaction between the inorganic nanosheets.

### Examples of Application Fields

The inorganic nanosheet composite according to the present embodiment can be used as a functional material applied to a composite material, a catalyst, an adsorbing material, a separation membrane, an electrode material, and the like. For example, the inorganic nanosheet composite can be applied to adsorbing/separating (for example, gas separation, water purification, contaminant removal, and the like), a functional thin film (for example, antibacterial, transparent conductive film, and the like), a solid ionic conductor (for example, a fuel cell, a soft actuator, and the like), a high specific surface area electrode (for example, a supercapacitor or the like), a photocatalyst, a solar cell, and the like. In particular, the inorganic nanosheet composite according to the present embodiment can exhibit various functions (as an example, the function of a visible-light-responsive photocatalyst) based on cationic species because the cationic species that exhibit a predetermined function exist between the layers of the monodisperse inorganic nanosheets having a high aspect ratio and a large specific surface area. Therefore, an inorganic nanosheet composite exhibiting a desired function can be obtained by appropriately selecting a combination of an inorganic nanosheet and a cationic species.

### Effects of Embodiment

The inorganic nanosheet composite according to the present embodiment can form the nanosheet laminated nanofibers in which the cationic species is located between the monodisperse inorganic nanosheets by combining the monodisperse inorganic nanosheets with the predetermined cationic species. That is, by combining anionic monodisperse inorganic nanosheets and a bulky cationic species, the attractive force between the monodisperse inorganic nanosheets can be controlled within a range in which the monodisperse inorganic nanosheets are not randomly aggregated, and a nanofiber in which the monodisperse inorganic nanosheets are laminated can be formed. Furthermore, in the inorganic nanosheet composite according to the present embodiment, the nanosheet laminated nanofibers and the nanosheet laminated nanofiber aggregate can be selectively formed by controlling the equivalent ratio of the cationic species to the ion exchange capacity of the monodisperse inorganic nanosheet.

Here, in a case where a conventional method of forming a laminated structure by controlling the salt concentration is adopted, when the solvent is removed from a nanosheet laminated nanofiber dispersion to form a solid, a large amount of salt remains, and thus a rinsing step is required. In addition, when a rinsing treatment is performed, the nanosheet laminated nanofiber may change to another structure (for example, the structure collapses). In contrast, in the inorganic nanosheet composite according to the present embodiment, since the interaction between the monodisperse inorganic nanosheets is controlled by the cationic species, the salt does not remain in large quantities. In addition, characteristics unique to the cationic species can also be imparted to the nanosheet laminated nanofiber (string-like structure of the monodisperse inorganic nanosheets).

In the inorganic nanosheet composite according to the present embodiment, various inorganic nanosheets can be used as the monodisperse inorganic nanosheets, and one cationic species can be replaced with another cationic species. Therefore, in an inorganic nanosheet composite using the one cationic species, a function based on the one cationic species is exhibited, and in an inorganic nanosheet composite using the other cationic species, a function based on the other cationic species is exhibited. Accordingly, with the inorganic nanosheet composite according to the present embodiment, an inorganic nanosheet composite exhibiting a desired function can be easily designed.

Hereinafter, the inorganic nanosheet composite according to the present embodiment will be specifically described using experimental examples.

### Experimental Example 1

### <Synthesis of Monodisperse Inorganic Nanosheet Colloid>

For the monodisperse inorganic nanosheet colloid, 33.4 mmol titanium tetraisopropoxide (TIP) was added to 150 mL of an aqueous solution of 0.273 mol/L tetramethylammonium hydroxide (TMAOH), and the mixture was stirred at room temperature under the air atmosphere for 60 minutes, and then refluxed at 80° C. under the air atmosphere for 24 hours. As a result, a monodisperse inorganic nanosheet colloid (monodisperse titania nanosheet colloid solution) was obtained. The concentration of the inorganic nanosheet colloidal solution of the monodispersed titania nanosheet thus obtained was 1.7 wt %, and the TMA+ concentration was 0.273 mol/L. The following reagents were used.
TMAOH: 25% aqueous solution of tetramethylammonium hydroxide (TMAOH) (manufactured by Tokyo Chemical Industry Co., Ltd.)
TIP: titanium tetraisopropoxide (manufactured by FUJIFILM Wako Pure Chemical Corporation)

### <Preparation of Metal Complex-Containing Aqueous Solution>

As a metal complex-containing aqueous solution, a ruthenium complex aqueous solution was prepared. Specifically, 2.94 g of tris(2,2′-bipyridine) ruthenium (II) chloride hexahydrate and 47.1 g of water were mixed and stirred at 500 rpm for 60 minutes to prepare 50.0 mL of an aqueous solution of 0.0779 mol/L [Ru(bpy)₃]²⁺. Next, in order to adjust the ratio (equivalent ratio) of the equivalent (molar equivalent, that is, substance amount/valence) of [Ru(bpy)₃]²⁺ to the ion exchange capacity (CEC) of the inorganic nanosheets, this aqueous solution of [Ru(bpy)₃]²⁺ was diluted with water. The following reagents were used. Here, CEC is the amount of cations that can be adsorbed by an inorganic nanosheet having a negative charge, being represented in the amount of cations per unit mass of the nanosheet, and the unit of CEC is meq/g. meq is a milliequivalent and means a substance amount (mmol)/valence of an ion. For example, the CEC of the titania nanosheets is 4.63 meq/g. Here, since the CEC of the divalent cation is calculated by multiplying the reciprocal of the valence, the adsorbable divalent [Ru(bpy)₃]²⁺ is 2.31 mmol/g calculated by multiplying the CEC of the titania nanosheet by ½.
Ruthenium complex: tris(2,2′-bipyridine) ruthenium (II) chloride hexahydrate (manufactured by Tokyo Chemical Industry Co., Ltd.)

More specifically, in a case where the ratio “Ru/CEC” of the equivalent of [Ru(bpy)₃]²⁺ to the ion exchange capacity of the inorganic nanosheet is controlled to, for example, “0.20”, and 1.0 g of a metal complex-containing aqueous solution having this ratio is prepared, since 0.20×(½)=0.10, it is possible to prepare an aqueous solution in which “Ru/CEC” contains 0.40 times the equivalent of [Ru(bpy)₃]₂₊ by mixing 0.10 g of an aqueous solution of [Ru(bpy)₃]²⁺ (0.0779 mol/L) and 0.90 g of water. Under such a principle, 1.00 g of an aqueous solution of [Ru(bpy)₃]²⁺ in which the equivalent ratio (Ru/CEC) of [Ru(bpy)₃]²⁺ to the ion exchange capacity (CEC) of the inorganic nanosheet is 0.2 times (0.2 times equivalent) was prepared. The concentration (mol/L) of [Ru(bpy)₃]²⁺ is as presented in Table 1.

### <Synthesis of Inorganic Nanosheet Composite>

### (Preparation of Inorganic Nanosheet Composite)

First, 1.00 g of an aqueous solution of a 0.20 times equivalent [Ru(bpy)₃]²⁺ and 1.00 g of a monodisperse inorganic nanosheet colloidal solution (monodisperse titania nanosheet colloidal solution) having an inorganic nanosheet concentration (titania nanosheet [mNS] concentration) of 1.7 wt % and a TMA⁺ concentration of 0.273 mol/L were mixed, and then the mixture was stirred at 300 rpm for 30 minutes. As a result, 2.00 g of a solution containing the inorganic nanosheet composite (ruthenium/titania nanosheet composite, it may be referred to as “[Ru(bpy)₃]²⁺-mNS”) with an inorganic nanosheet concentration of 1.10 wt % and a TMA⁺ concentration of 0.137 mol/L was prepared. The equivalent ratio of [Ru(bpy)₃]²⁺ to the ion exchange capacity (CEC) of the inorganic nanosheet of this inorganic nanosheet composite ([Ru(bpy)₃]²⁺/CEC) was 0.20 times equivalent. As a result, a sample of [Ru(bpy)₃]²⁺-mNS according to Experimental Example 2 was obtained.

### Experimental Example 1, Experimental Examples 3 to 13, and Experimental Example 14

In addition, samples of [Ru(bpy)₃]²⁺-mNS according to the experimental examples (Experimental Example 1 and Experimental Examples 3 to 13) in which the equivalent ratio of [Ru(bpy)₃]²⁺ to the ion exchange capacity (CEC) of the inorganic nanosheet was 0.10 times equivalent to 2.0 times equivalent were also prepared using a monodisperse inorganic nanosheet colloid prepared in the same manner as in Experimental Example 2 and 1.00 g of an aqueous solution of [Ru(bpy)₃]²⁺ prepared to each factor's equivalent. Furthermore, a sample not using an aqueous solution of [Ru(bpy)₃]²⁺ (a “0 times equivalent” sample, where [Ru(bpy)₃]²⁺/CEC=0) was also prepared (Experimental Example 14). The equivalent ratio of [Ru(bpy)₃]²⁺ to the ion exchange capacity (CEC) and the concentration (mol/L) of [Ru(bpy)₃]²⁺ of the inorganic nanosheet in each sample are as presented in Table 1.

TABLE 1

| | | 0.0779 mol/l | | [Ru | |
|---|---|---|---|---|---|
| | [Ru | of aqueous | | (bpy)₃²⁺] | [mNS] |
| | (bpy)₃]²⁺/ | solution of | Water | Density | Density |
| Sample | CEC | Ru (bpy)₃²⁺ | (ml) | (mol/l) | (wt %) |
| Experimental | 0.0 | 0.0 | 1.0 | 0.0 | 1.1 |
| Example 14 | | | | | |
| Experimental | 0.10 | 0.05 | 0.95 | 0.0019 | 1.1 |
| Example 1 | | | | | |
| Experimental | 0.20 | 0.10 | 0.90 | 0.0039 | 1.1 |
| Example 2 | | | | | |
| Experimental | 0.40 | 0.20 | 0.80 | 0.0078 | 1.1 |
| Example 3 | | | | | |
| Experimental | 0.50 | 0.25 | 0.75 | 0.0097 | 1.1 |
| Example 4 | | | | | |
| Experimental | 0.60 | 0.30 | 0.70 | 0.012 | 1.1 |
| Example 5 | | | | | |
| Experimental | 0.70 | 0.35 | 0.65 | 0.014 | 1.1 |
| Example 6 | | | | | |
| Experimental | 0.80 | 0.40 | 0.60 | 0.016 | 1.1 |
| Example 7 | | | | | |
| Experimental | 0.90 | 0.45 | 0.55 | 0.018 | 1.1 |
| Example 8 | | | | | |
| Experimental | 1.0 | 0.50 | 0.50 | 0.019 | 1.1 |
| Example 9 | | | | | |
| Experimental | 1.2 | 0.60 | 0.40 | 0.023 | 1.1 |
| Example 10 | | | | | |
| Experimental | 1.4 | 0.70 | 0.30 | 0.027 | 1.1 |
| Example 11 | | | | | |
| Experimental | 1.6 | 0.80 | 0.20 | 0.031 | 1.1 |
| Example 12 | | | | | |
| Experimental | 2.0 | 1.0 | 0.0 | 0.039 | 1.1 |
| Example 13 | | | | | |

For the sample according to Experimental Example 9, collection of nanosheet laminated nanofibers, which are formed inorganic nanosheet composites, was attempted using the following rinsing method.

### (Rinsing Method)

Salt was removed from a solution containing the prepared inorganic nanosheet composite according to Experimental Example 9, and the residue was rinsed. As a result, a solid sample of Ru(bpy)₃²⁺-mNS according to Experimental Example 9 was obtained. The method for removing salt is as follows.

The solution containing the prepared inorganic nanosheet composite ([Ru(bpy)₃]²⁺-mNS) was left to stand for phase separation into a precipitate and a supernatant liquid, and the supernatant was removed. Then, water was added to the precipitate so as to have the same mass as the mass after preparation of the inorganic nanosheet composite, the mixture was stirred and left to stand for phase separation again, and a supernatant liquid was removed after the phase separation. This operation was performed twice in total.

### Characterization-Measurement Method, etc.

### (Visual Observation-Crossed Nicols Observation)

Each of the samples according to Experimental Examples 1 to 14 was visually observed, and then the presence or absence of stationary birefringence and flow birefringence was confirmed by the crossed Nicols observation. For confirmation of stationary birefringence, each sample was enclosed in a 0.50 mm silicone spacer and visually observed. In addition, for confirmation of flow birefringence, each sample was put in a screw tube and visually observed under a crossed Nicols condition.

### (Polarizing Microscope (POM) Observation)

For each of the samples according to Experimental Examples 1 to 14, the state and birefringence of the structure of [Ru(bpy)₃]²⁺-mNS were observed using a polarizing microscope (POM) (BX51-P manufactured by OLYMPUS Corporation). Specifically, each sample was enclosed in a 0.50 mm silicone spacer, the enclosed sample was covered with a cover glass, and observed using the polarizing microscope.

### (UV-Visible Spectrophotometer (UV-Vis) Measurement)

In order to derive the wavelength range of light absorbed by the metal-ligand charge transfer state (MLCT) of [Ru(bpy)₃]²⁺ in the prepared ruthenium complex aqueous solution and to derive the unknown concentration thereof, measurement was performed for each of the samples of the titania nanosheet aqueous solution, the prepared ruthenium complex aqueous solution (aqueous solution of [Ru(bpy)₃]²⁺), and Experimental Examples 1 to 13 using an ultraviolet-visible spectrophotometer (U-2910 manufactured by HITACHI) that can obtain a quantitative analysis and an absorption spectrum acquired by plotting absorbance for each wavelength of light, of a liquid sample.

### (Fluorescence Spectrophotometer (FL) Measurement)

The range of wavelengths at which the solution of the ruthenium/titania nanosheet composite ([Ru(bpy)₃]²⁺-mNS) emits fluorescence in each of the samples of Experimental Examples 1 to 14 and the ruthenium complex aqueous solution (aqueous solution of [Ru(bpy)₃]²⁺) was measured using a fluorescence spectrophotometer (F-2500 manufactured by HITACHI).

### (Fluorescence Microscope (FM) Observation)

In order to confirm the formation of a nanosheet laminated nanofiber of [Ru(bpy)₃]²⁺ and mNSs in the ruthenium/titania nanosheet composite ([Ru(bpy)₃]²⁺-mNS) in each of the sample of Experimental Example 8 and an mNS ethanol water mixed solution, observation was performed using a fluorescence microscope (BZ-X800 manufactured by KEYENCE Corporation). A fluorescence filter used for the observation was a BZ-X-GFP filter (excitation wavelength: 470±20 nm, dichroic mirror wavelength: 495 nm or more, absorption wavelength: 525±25 nm), and fluorescence emitted when the ruthenium complex was excited to relax to the ground state was observed. The observed fluorescence image was illustrated in orange to match the fluorescence emitted by the ruthenium complex.

### (Confocal Laser Microscope (CLSM) Observation)

For each of the samples according to Experimental Example 14, Experimental Example 1, Experimental Example 6, Experimental Example 7, Experimental Example 8, Experimental Example 9, Experimental Example 10, and Experimental Example 13, the presence or absence of a nanosheet laminated nanofiber by a composite of monodispersed titania nanosheets and a ruthenium complex ([Ru(bpy)₃]²⁺) was observed using a confocal laser microscope (A1R+ manufactured by Nikon Instech Co., Ltd.). In the confocal laser microscope, an object can be observed using two types of lasers, that is, a laser having a wavelength of 488 nm and a laser having a wavelength of 405 nm. Since a scattering image is obtained by observation using a laser having a wavelength of 405 nm, a structure or the like of an object in a solution can be observed. In contrast, since a fluorescent image is obtained by observation using a laser having a wavelength of 488 nm, a fluorescent dye or the like adsorbed to an object can be observed. Here, in order to observe the presence or absence of the nanosheet laminated nanofiber, a fluorescence image of each sample was observed using a laser having a wavelength of 488 nm. Specifically, a sample was dropped on the bottom surface of a glass bottom dish, and a scattered image of the sample was observed using the confocal laser microscope.

### (Small-Angle X-Ray Scattering/Wide-Angle X-Ray Scattering (SAXS/WAXS) Measurements)

The structure of the monodispersed titania nanosheet colloid and the structure of the nanosheet laminated nanofiber of the ruthenium/titania nanosheet composite ([Ru(bpy)₃]²⁺-mNS) in each of the samples according to Experimental Examples 1 to 14 were measured using small-angle X-ray scattering (SAXS) and wide-angle X-ray scattering (WAXS) (NANOPIX manufactured by Rigaku Corporation, measurement conditions: camera length=720 mm; CuKα characteristic X-ray; 40 kV-30 mA; and a two-dimensional CCD detector). In the small-angle X-ray scattering measurement, a sample to be measured was enclosed in a capillary (manufactured by WJM-Glas) having an inner diameter of 2.0 mm and was measured for 30 minutes. In contrast, the wide-angle X-ray scattering measurement was performed for 90 minutes. In the small-angle/wide-angle X-ray scattering measurement, in the graph representing a scattering intensity I with respect to a scattering vector q obtained by circularly integrating the two-dimensional pattern, it is assumed that there is a rod-shaped structure when the power law of I to q⁻¹ is observed, and it is assumed that there is a disk-shaped structure when the power law of I to q⁻² is observed.

### (Atomic Force Microscope (AFM) Observation)

The presence or absence of formation of nanosheet laminated nanofiber of the ruthenium/titania nanosheet composite ([Ru(bpy)₃]²⁺-mNS) in the sample according to Experimental Example 2 was observed using an atomic force microscope (AFM) (AFM5000II manufactured by HITACHI). Specifically, the sample according to Experimental Example 2 was diluted 50 times, and the diluted sample was dropped onto a mica substrate, dried, and then observed.

### (Transmission Electron Microscope (TEM) Observation)

The presence or absence of formation of nanosheet laminated nanofiber of the ruthenium/titania nanosheet composite ([Ru(bpy)₃]²⁺-mNS) in each of the samples according to Experimental Example 4, Experimental Example 7, and Experimental Example 13 was observed using a transmission electron microscope (TEM) (JEM-1400 manufactured by JEOL). In order to obtain a high-contrast image, a tungsten filament was used as a radiation source. Specifically, each of the samples was measured at an acceleration voltage of 80 kV using a grid (HRC-M10) of a carbon-supported membrane having a membrane thickness of 15 nm. A sample for TEM observation was prepared by diluting each of the samples 50 times with pure water, dropping 1 μL of the diluted sample, holding the sample for 30 seconds, sucking moisture with filter paper, and drying the sample in a desiccator.

### Characterization-Measurement Results

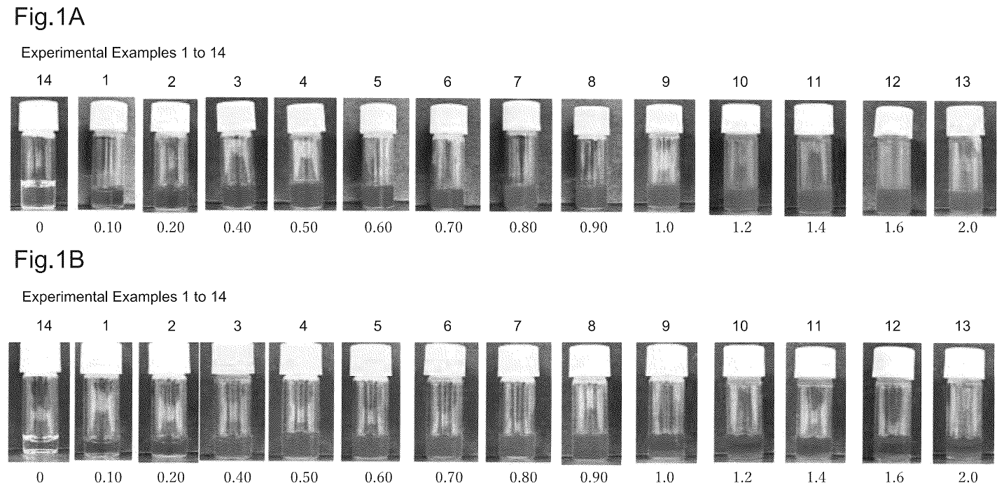

FIGS. 1A and 1B illustrate the visual-observation results of the samples according to Experimental Examples 1 to 14. Specifically, FIG. 1A illustrates the visual observation results immediately after preparation of the samples according to Experimental Examples 1 to 14, and FIG. 1B illustrates the visual observation results after the samples according to Experimental Examples 1 to 14 were left to stand for 24 hours after preparation. The numerical value described under each figure indicates the value of ([Ru(bpy)₃]²⁺/CEC (equivalent ratio)).

### (Visual Observation Results)

First, the samples according to Experimental Examples 1 to 14 (aqueous solutions containing [Ru(bpy)₃]²⁺-mNS) were visually observed, and as illustrated in FIG. 1A, no cloudiness was observed in the samples in Experimental Example 14 and Experimental Examples 1 to 6. In contrast, in the sample in Experimental Example 7 (a sample in which the ratio of the equivalent of [Ru(bpy)₃]²⁺ to the ion exchange capacity (CEC) of the inorganic nanosheet is 0.80 times equivalent; hereinafter, the equivalent ratio of [Ru(bpy)₃]²⁺ to the ion exchange capacity (CEC) of the inorganic nanosheet may be simply referred to as “equivalent ratio”), cloudiness began to be observed, and cloudiness was observed in the sample from Experimental Example 7 to Experimental Example 13. That is, it was observed that when the equivalent ratio became 0.80 times equivalent or more, the aqueous solutions containing [Ru(bpy)₃]²⁺-mNS began to be cloudy.

The samples according to Experimental Examples 1 to 14 were left to stand at room temperature in the air atmosphere for 24 hours, and then visually observed again. As a result, as illustrated in FIG. 1B, in the sample according to Experimental Example 9 (equivalent ratio: 1.0 time equivalent) to the sample according to Experimental Example 13 (equivalent ratio: 2.0 times equivalent), separation into a supernatant and a precipitate was observed. It is considered that the tendency of phase separation increases as the concentration of [Ru(bpy)₃]²⁺ increases.

### (Results of Crossed Nicols Observation)

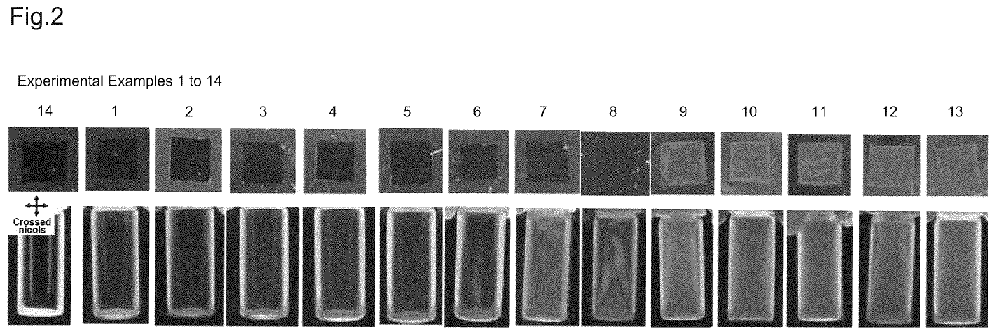

FIG. 2 illustrates the results of the crossed Nicols observations of the samples according to Experimental Examples 1 to 14.

As can be seen with reference to FIG. 2, no birefringence was observed in the samples according to Experimental Example 14 (equivalent ratio: 0 times equivalent) to Experimental Example 5 (equivalent ratio: 0.60 times equivalent). In contrast, flow birefringence was observed in the sample of Experimental Example 6 (equivalent ratio: 0.70 times equivalent) and subsequent samples, and stationary birefringence was observed in the samples of Experimental Example 9 (equivalent ratio: 1.0 time equivalent) and subsequent samples. In the samples of Experimental Examples 9 (equivalent ratio: 1.0 time equivalent) to 13 (equivalent ratio: 2.0 times equivalent), no birefringence was observed. It is considered that no birefringence was observed because the [Ru(bpy)₃]²⁺ concentration was high in Experimental Examples 9 to 13. From these results, it was revealed that when the equivalent ratio was at least 0.70 times equivalent or more, flow birefringence was observed, and when the equivalent ratio was 1.0 time equivalent or more, stationary birefringence was observed.

### (Results of Polarizing Microscope Observation)

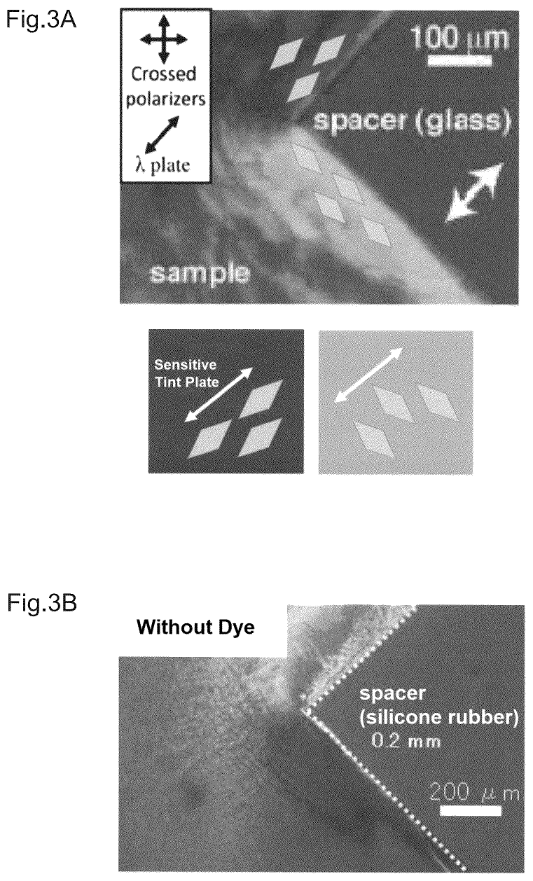

FIGS. 3A and 3B illustrate the results of polarizing microscope observation of the samples in which conventional inorganic nanosheets are uniformly dispersed. Specifically, FIG. 3A illustrates the result in the previous report of polarizing microscope observation of the sample in which inorganic nanosheets are uniformly dispersed, and FIG. 3B illustrates the result of polarizing microscope observation of the sample of inorganic nanosheets into which a metal complex is not introduced (inorganic nanosheets without dye).

It has been reported that when conventional inorganic nanosheets are not laminated but uniformly dispersed, the interference color illustrated in FIG. 3A can be observed (N. Miyamoto and T. Nakato, Adv. Mater., 2002, 14, 1267). This is observed because blue is exhibited when the inorganic nanosheet is parallel to the interface of a sensitive tint plate and yellow is exhibited when the inorganic nanosheet is perpendicular to the interface of the sensitive tint plate. From this, in the conventional monodispersed titania nanosheet colloidal solution, it can be determined that there is a portion where the titania nanosheet is arranged in parallel with the interface of the sensitive tint plate.

As illustrated in FIG. 3B, when an elongated string-like structure (nanosheet laminated nanofiber) was formed in a sample in which the [Ru(bpy)₃]²⁺ complex was not introduced ([TMA⁺]=2.2 M, inorganic nanosheet concentration=10 wt %), yellow was observed in a portion parallel to the interface of the sensitive tint plate, and blue was observed in a portion perpendicular to the interface of the sensitive tint plate. From this, when an elongated structure is formed without introducing the [Ru(bpy)₃]²⁺ complex, it can be determined that there is a portion where the inorganic nanosheet is oriented perpendicular to the interface.

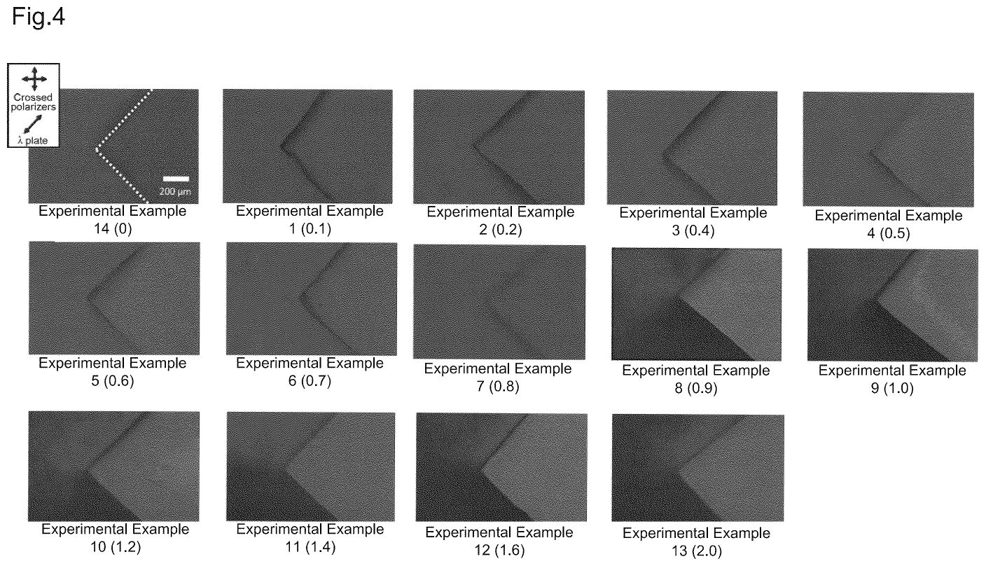

FIG. 4 illustrates the results of polarizing microscope observations of the samples according to Experimental Examples 1 to 14. The numerical value described in parentheses after the text of the experimental example on each drawing indicates the value of ([Ru(bpy)₃]²⁺/CEC (equivalent ratio).

As can be seen with reference to FIG. 4, nothing was observed in the sample of Experimental Example 7 (equivalent ratio: 0.80 times equivalent) and the antecedent samples in the polarizing microscope (POM) observation, and in the samples of Experimental Example 8 (equivalent ratio: 0.90 times equivalent) to Experimental Example 13 (equivalent ratio: 2.0 times equivalent), interference colors (orange and black) were observed at the interface on the spacer in each sample. This is considered that the [Ru(bpy)₃]²⁺ complex was introduced, whereby yellow was changed to orange and blue was changed to black. From this, it was revealed that when the [Ru(bpy)₃]²⁺ complex was introduced, orange was observed when the interface of the sensitive tint plate was parallel, and black was observed when the interface of the sensitive tint plate was perpendicular. Therefore, it was confirmed that the elongated structure was maintained even after introduction of the [Ru(bpy)₃]²⁺ complex.

### (UV-Vis Measurement Results)

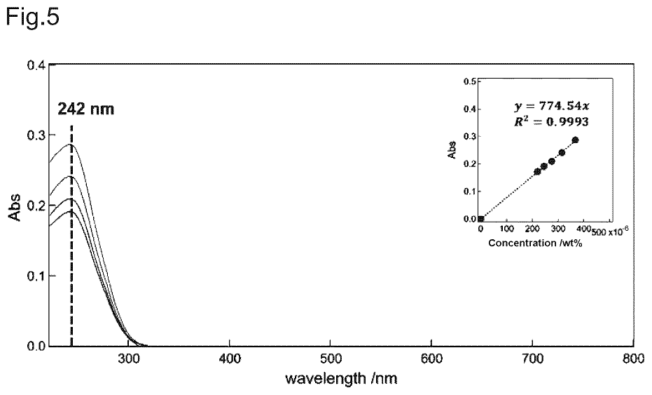

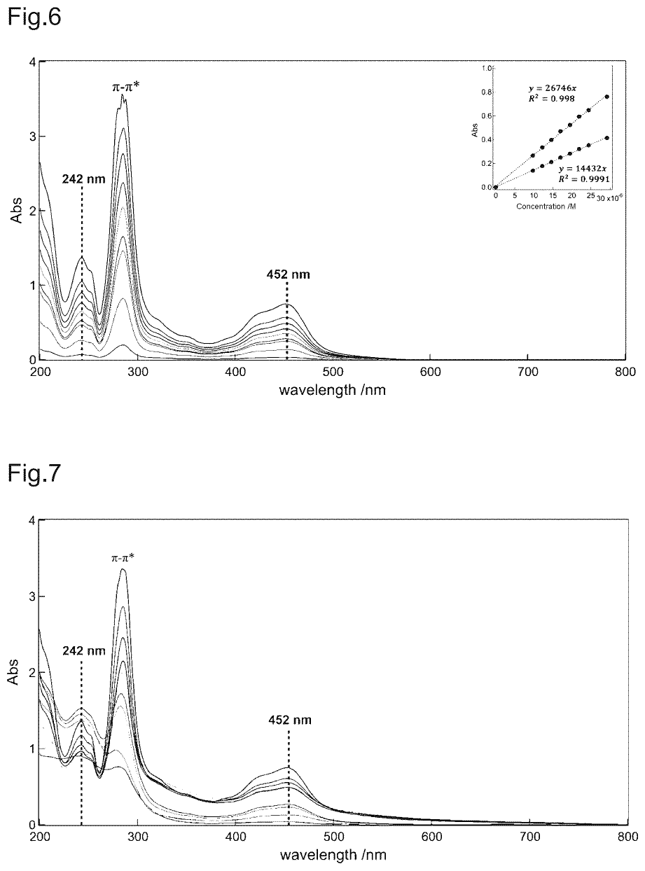

FIG. 5 illustrates a diagram of the UV-vis measurement and the calibration curve of the titania nanosheet, FIG. 6 illustrates a diagram of the UV-vis measurement and the calibration curve of the ruthenium complex aqueous solution, and FIG. 7 illustrates the UV-vis measurement result of the ruthenium/titania nanosheet composite ([Ru(bpy)₃]²⁺-mNS).

An absorption spectrum was measured by UV-Vis measurement for each of the samples of the titania nanosheet (mNS) aqueous solution (see FIG. 5 and Table 2), the ruthenium complex aqueous solution (aqueous solution of [Ru(bpy)₃]²⁺ (Experimental Examples 1 to 13) (see FIG. 6 and Table 3)), and the composite sample of [Ru(bpy)₃]²⁺ and titania nanosheets (mNSs) (Experimental Examples 1 to 13) (see Table 4 and FIG. 7). The concentration of the mNS aqueous solution was in the range of 2.20×10⁻⁴ wt % to 3.67×10⁻⁴ wt %. The ruthenium complex aqueous solution (aqueous solution of [Ru(bpy)₃]²⁺) was in the range of 1.0×10⁻⁵ M to 3.0×10⁻⁵ M. The composite samples of the titania nanosheets (mNSs) (Experimental Examples 1 to 13) were diluted 800 times and used for the measurement. In the titania nanosheet (mNS) aqueous solution, as the nanosheet concentration increased, the absorbance (band gap absorption) peaking at 242 nm increased in the ultraviolet region (FIG. 5). In the aqueous solution of [Ru(bpy)₃]²⁺, as the concentration of [Ru(bpy)₃]²⁺ increased, the peaks at 242 nm (π−π* transition) and 452 nm (MLCT absorption) increased (FIG. 6). Here, the increase of these concentrations was according to the following Lambert-Beer equation:

A_{(λ)}=ε_{(λ)}Cl

Here, at a wavelength λ of light, A_{(λ)} is absorbance, ε_{(λ)} is absorbance coefficient (“L mol⁻¹ cm⁻¹” or [wt %⁻¹ cm⁻¹], C ([mol/L] or [wt %]) is the concentration of a light absorbing substance, and 1 (cm) is the optical path length of a cell container. In this experiment, the optical path length was 1 cm. In the mNS aqueous solution, from the calibration curve illustrated in the inset of FIG. 5, ε₍₂₄₂ₙₘ₎=774.54 [wt %⁻¹ cm⁻¹] and ε₍₄₅₂ₙₘ₎=0 [wt %⁻¹ cm⁻¹] were obtained. In the aqueous solution of [Ru(bpy)₃]²⁺, from the calibration curves illustrated in the inset of FIG. 6, ε₍₂₄₂ₙₘ₎=26746 [L mol⁻¹cm⁻¹] and ε_{(452 nm)}=14432 [L mol⁻¹ cm⁻¹]. In contrast, in the composite sample of [Ru(bpy)₃]²⁺ and titania nanosheets (mNSs), a spectrum obtained by adding the absorption by the titania nanosheet (mNS) and the absorption by [Ru(bpy)₃]²⁺ was obtained (FIG. 7). From this, it was revealed that the concentrations of mNS, Ru, and [Ru(bpy)₃]²⁺ in the present composite system were able to be easily determined by UV-Vis measurement.

TABLE 2

| [NS]/wt % | A₂₄₂ |
|---|---|
| 2.20 × 10⁻⁴ | 0.172 |
| 2.44 × 10⁻⁴ | 0.191 |
| 2.75 × 10⁻⁴ | 0.209 |
| 3.14 × 10⁻⁴ | 0.241 |
| 3.67 × 10⁻⁴ | 0.287 |

TABLE 3

| [Ru (bpy)₃²⁺]/M | A₂₄₂ | A₄₅₂ |
|---|---|---|
| 1.0 × 10⁻⁵ | 0.265 | 0.139 |
| 1.3 × 10⁻⁵ | 0.334 | 0.178 |
| 1.5 × 10⁻⁵ | 0.397 | 0.212 |
| 1.8 × 10⁻⁵ | 0.470 | 0.250 |
| 2.0 × 10⁻⁵ | 0.523 | 0.282 |
| 2.3 × 10⁻⁵ | 0.594 | 0.321 |
| 2.5 × 10⁻⁵ | 0.648 | 0.352 |
| 3.0 × 10⁻⁵ | 0.761 | 0.414 |

TABLE 4

| | [Ru | [Ru | | | |
|---|---|---|---|---|---|
| | (bpy)₃]²⁺/ | (bpy)₃²⁺]/ | | | [NS] |
| Sample | CEC | M | Abs₂₄₂ | Abs₄₅₂ | wt % |
| Experimental | 0.10 | 2.4 × 10⁻⁶ | 0.889 | 0.0400 | 0.00138 |
| Example 1 | | | | | |
| Experimental | 0.20 | 4.9 × 10⁻⁶ | 1.10 | 0.780 | 0.00138 |
| Example 2 | | | | | |
| Experimental | 0.40 | 9.7 × 10⁻⁶ | 1.37 | 0.128 | 0.00138 |
| Example 3 | | | | | |
| Experimental | 0.50 | 1.2 × 10⁻⁵ | 1.38 | 0.151 | 0.00138 |
| Example 4 | | | | | |
| Experimental | 0.60 | 1.5 × 10⁻⁵ | 1.42 | 0.176 | 0.00138 |
| Example 5 | | | | | |
| Experimental | 0.70 | 1.7 × 10⁻⁵ | 1.45 | 0.231 | 0.00138 |
| Example 6 | | | | | |
| Experimental | 0.80 | 1.9 × 10⁻⁵ | 1.53 | 0.267 | 0.00138 |
| Example 7 | | | | | |

### (FL Measurement Results)

For each of the samples of Experimental Examples 1 to 13 and an aqueous solution containing only the ruthenium complex (aqueous solution of [Ru(bpy)₃]²⁺, 2.5×10⁻⁶ M to 5×10⁻⁵ M), a fluorescence spectrum and a fluorescence excitation spectrum of [Ru(bpy)₃]²⁺ were measured. In the FL measurement, the sample was irradiated with an excitation wavelength of 452 nm, and a fluorescence peak was observed at wavelengths from about 612 nm to 590 nm. In each of the samples in which the titania nanosheets were combined with [Ru(bpy)₃]²⁺, the peak shifted to the short wavelength side and the fluorescence intensity increased, as the ruthenium concentration increased. In the ruthenium complex aqueous solution, a fluorescence peak was observed at a wavelength of about 589 nm.

In addition, in the fluorescence excitation spectrum, fluorescence excitation intensity of a peak derived from the MLCT absorption band was observed in the vicinity of about 451 nm to 455 nm. It was confirmed that the fluorescence intensity tended to increase as the concentration of ruthenium increased.

From the above results, it was assumed that when the introduction amount of [Ru(bpy)₃]²⁺ was low as in the samples of Experimental Example 1 (equivalent ratio: 0.10 times equivalent) to Experimental Example 4 (equivalent ratio: 0.50 times equivalent), the energy level of the electron orbit of [Ru(bpy)₃]²⁺ was changed based on the adsorption of [Ru(bpy)₃]²⁺ to the nanosheet, and the fluorescence wavelength shifted to a longer wavelength. In the aqueous solution in which the introduction amount of [Ru(bpy)₃]²⁺ is large (that is, 1.0 time equivalent), an excessive amount of [Ru(bpy)₃]²⁺ is present in the solution. Therefore, as a result of an increase in the concentration of [Ru(bpy)₃]²⁺ not combined with an mNS, the fluorescence wavelength is considered to have approached the aqueous solution of only [Ru(bpy)₃]²⁺.

### (FM Observation Results)

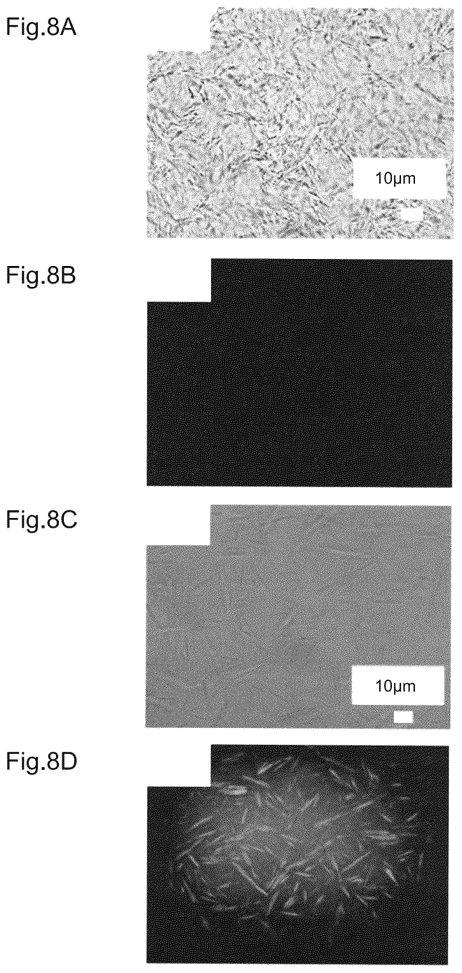

FIGS. 8A to 8D illustrate the results of FM observation. Specifically, FIGS. 8A and 8B illustrate the results of the FM observation of an mNS ethanol-water mixed solution, and FIGS. 8C and 8D illustrate the results of the FM observation of the sample according to Experimental Example 8.

In the FM observation, the sample according to Experimental Example 8 was compared with an mNS ethanol-water mixed solution prepared using a titania nanosheet (mNS) concentration of 0.50 wt %, a TMA⁺ concentration of 0.080 mol/L, ethanol of 70 wt %, and water of 30 wt %. As a result, in the mNS ethanol-water mixed solution, a large number of elongated structures were observed with white light (see FIG. 8A), but nothing was observed in the fluorescence image (see FIG. 8B). In contrast, in the sample according to Experimental Example 8, orange elongated structures were observed with white light (see FIG. 8C), and orange light emitters were observed in the fluorescence image (see FIG. 8D). As a result, in Experimental Example 8, it was confirmed that mNSs were combined with [Ru(bpy)₃]²⁺ to form nanosheet laminated nanofibers.

### (Confocal Laser Microscope Observation Results)

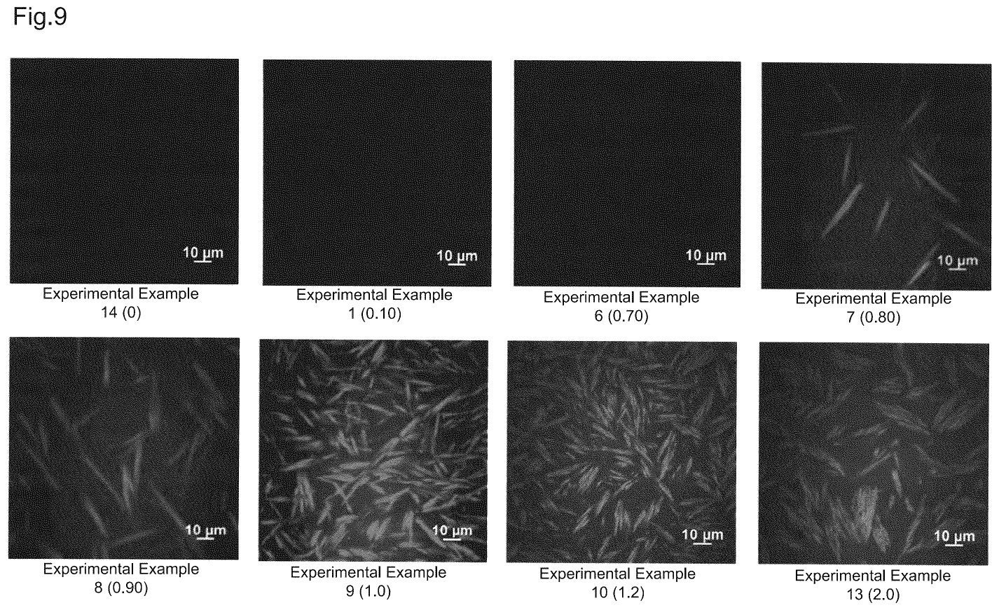

FIG. 9 illustrates the results of confocal laser microscope observation of the samples according to Experimental Examples 1, 6, 7, 8, 9, 10, 13, and 14.

As can be seen with reference to FIG. 9, in the confocal laser microscope (CLSM) observation, nothing was observed in the sample of Experimental Example 6 (equivalent ratio: 0.70 times equivalent) and the antecedent samples, nanosheet laminated nanofibers were observed from Experimental Example 7 (equivalent ratio: 0.80 times equivalent), elongated string-like nanosheet laminated nanofibers and aggregates thereof were observed in the sample of Experimental Example 8 (equivalent ratio: 0.90 times equivalent), and aggregates of string-like nanosheet laminated nanofibers were observed in the samples of Experimental Example 9 (equivalent ratio: 1.0 time equivalent) to Experimental Example 13 (equivalent ratio: 2.0 times equivalent). Therefore, in the CLSM observation, it was confirmed that elongated string-like nanosheet laminated nanofibers having a size not observed in the POM observation began to be formed in the sample of Experimental Example 7 (equivalent ratio: 0.80 times equivalent). That is, it was revealed that, by controlling the equivalent ratio to at least 0.80 times equivalent or more, nanosheet laminated nanofibers as an inorganic nanosheet composite (composite of titania nanosheets and a ruthenium complex) were formed, and by setting the equivalent ratio to 1.0 time equivalent or more, an aggregate of nanosheet laminated nanofibers was formed.

### (Results of Small-Angle X-Ray Scattering/Wide-Angle X-Ray Scattering Measurements)

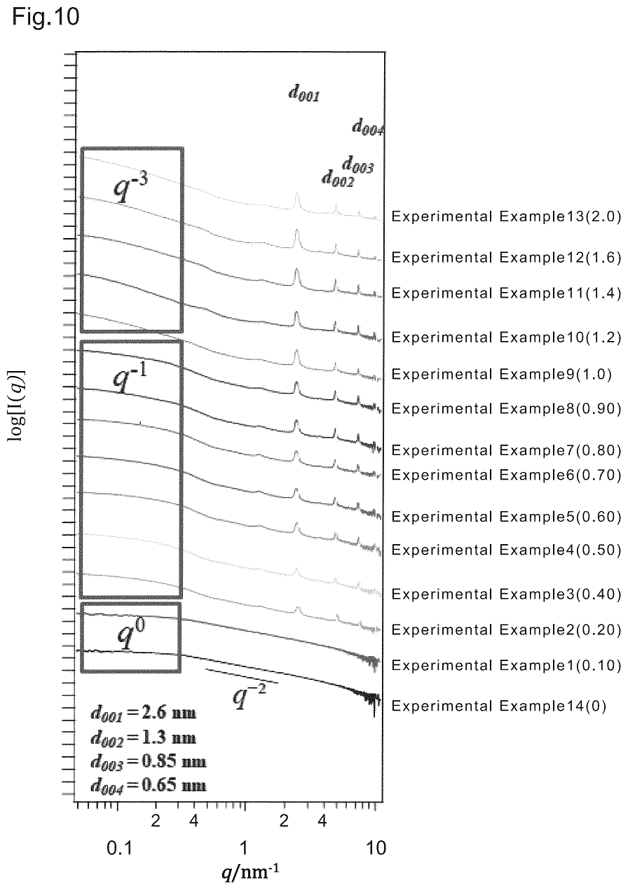

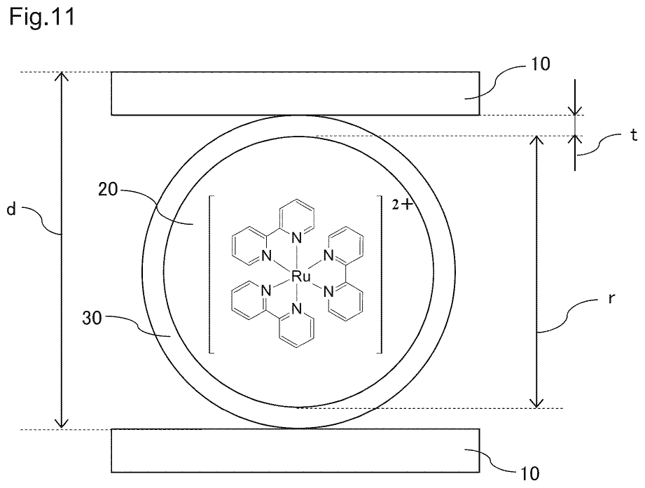

FIG. 10 illustrates the results of the small-angle/wide-angle X-ray scattering measurement of the samples according to Experimental Examples 1 to 14. In addition, FIG. 11 illustrates a conceptual diagram of the ruthenium/titania nanosheet composite ([Ru(bpy)₃]²⁺-mNS). The numerical value described in parentheses after the text of each of the experimental examples in FIG. 10 indicates the value of ([Ru(bpy)₃]²⁺/CEC (equivalent ratio).

For each of the samples according to Experimental Examples 1 to 14, the nanosheet laminated nanofibers were measured using small-angle X-ray scattering and wide-angle X-ray scattering. As can be seen with reference to FIG. 10, in the graphs of the scattering intensity I with respect to the scattering vector q in the samples of Experimental Example 14 (equivalent ratio: 0 times equivalent) and Experimental Example 1 (equivalent ratio: 0.10 times equivalent), the slope of I was q⁻² in the region of q>0.4 nm, and the slope of I was constant in the region of q<0.4 nm on the small-angle side. The shape of these graphs is similar to the shape factor function of a thin disk shape. Here, fitting was performed using a shape factor function of a thin disk shape, and it was confirmed that the measurement results of the samples of Experimental Example 14 and Experimental Example 1 indicated the presence of an isotropic phase in which titania nanosheets one side of which was about 13 nm were dispersed.

From the sample of Experimental Example 2 (equivalent ratio: 0.20 times equivalent) to the sample of Experimental Example 8 (equivalent ratio: 0.90 times equivalent), in the graphs of scattering intensity I with respect to scattering vector q, regions with the slope of q⁻¹ indicating the presence of a rod-shaped structure were observed on the small-angle side, and a plurality of peaks were observed on the wide-angle side. As illustrated in FIG. 11, these peaks were considered to be peaks derived from ½, ⅓, and ¼ of an interlayer distance d (plane spacing) of 2.6 nm in a case where [Ru(bpy)₃]²⁺ and titania nanosheets were combined. FIG. 11 illustrates a conceptual diagram of a state in which a ruthenium complex 20 is located together with hydrated water 30 between the layers of the titania nanosheets 10. The thickness of the titania nanosheet 10 illustrated in FIG. 11 is 0.65 nm. The ruthenium complex 20 has a particle size r of 1.01 nm excluding the hydrated water 30, and the hydrated water 30 has a thickness t of 0.47 nm. Therefore, it is considered that nanosheet laminated nanofibers in which [Ru(bpy)₃]²⁺ and titania nanosheets are combined are formed in the samples from Experimental Example 2 (equivalent ratio: 0.20 times equivalent) to Experimental Example 8 (equivalent ratio: 0.90 times equivalent), and aggregates of the nanosheet laminated nanofibers in which [Ru(bpy)₃]²⁺ and titania nanosheets are combined are formed in the samples from Experimental Example 9 (equivalent ratio: 1.0 time equivalent) to at least Experimental Example 12 (equivalent ratio: 1.6 times equivalent).

Furthermore, in the graphs of the scattering intensity I with respect to the scattering vector q on the small-angle side of the samples from Experimental Example 9 (equivalent ratio: 1.0 time equivalent) to Experimental Example 13 (equivalent ratio: 2.0 times equivalent), regions with the slope of q⁻³ indicating the presence of a larger object with a shape different from a rod or a nanosheet were observed. Therefore, it is considered that in the samples from Experimental Example 9 (equivalent ratio: 1.0 time equivalent) to Experimental Example 13 (equivalent ratio: 2.0 times equivalent), that is, in the samples of 1.0 time equivalent or more, aggregates of nanosheet laminated nanofibers were formed.

That is, in the small-angle/wide-angle X-ray scattering measurement, it was revealed that, although it was not confirmed by the POM and CLSM measurements, by controlling the equivalent ratio to 0.20 times equivalent or more, formation of nanosheet laminated nanofibers as an inorganic nanosheet composite (composite of titania nanosheets and a ruthenium complex) began, and by setting the equivalent ratio to 1.0 time equivalent or more, an aggregate of nanosheet laminated nanofibers was formed.

### (TEM Observation Results)

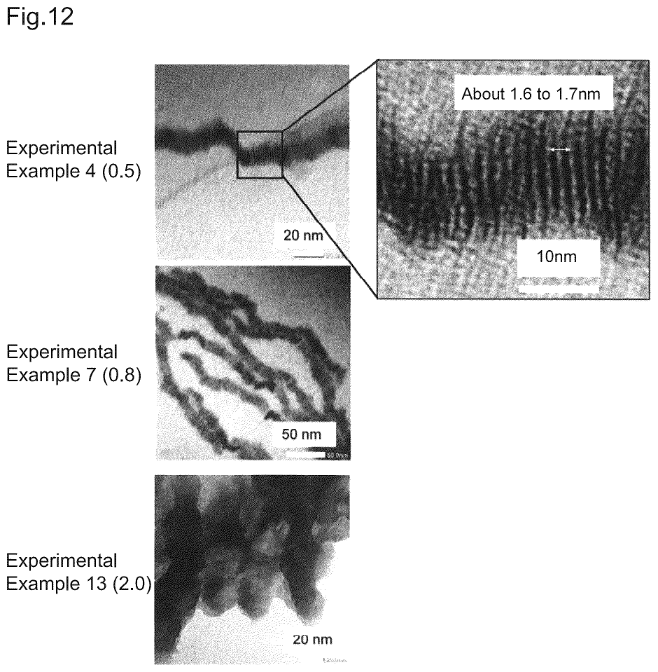

FIG. 12 illustrates the results of the TEM observation of the samples according to Experimental Example 4, Experimental Example 7, and Experimental Example 13. The numerical value described in parentheses after the text of each of the experimental examples in FIG. 12 indicates the value of ([Ru(bpy)₃]²⁺/CEC (equivalent ratio).

Diluted samples were prepared by diluting the respective samples of Experimental Example 4 (equivalent ratio: 0.50 times equivalent), Experimental Example 7 (equivalent ratio: 0.80 times equivalent), and Experimental Example 13 (equivalent ratio: 2.0 times equivalent) 50 times. Then, each of the prepared diluted samples was observed using a TEM. As a result, in the sample of Experimental Example 4, a nanosheet laminated nanofiber having an interlayer distance of 1.6 nm to 1.7 nm was observed. As can be seen with reference to the TEM image of Experimental Example 4 in FIG. 12, the width of the string-like structure in the short axis was substantially uniform, and density patterns were observed at regular intervals in parallel with the short axis. From this, it was confirmed that the string-like structure was made of the monodisperse inorganic nanosheets laminated in parallel with the short axis. Note that, in the results of the small-angle/wide-angle X-ray scattering measurement, a peak indicating an interlayer distance of 2.6 nm was observed, but it was different from the interlayer distance observed with the TEM. The reason for this is considered to be that [Ru(bpy)₃]²⁺ between layers was hydrated in the small-angle/wide-angle X-ray scattering measurement, but was dehydrated as observed in vacuum in the TEM observation. In the sample of Experimental Example 7, string-like structures each having a diameter of 20 nm and a length of about several hundred nm to several μm (typically about 100 nm) were observed on the grid. It was observed that the length of the structures in the sample of Experimental Example 7 was longer than the length of the structure in the sample of Experimental Example 4, and it was observed that the string-like structures were in contact with each other at a plurality of places. Furthermore, in the sample of Experimental Example 13, rod-shaped giant particles (accumulates of nanosheet laminated nanofibers) were observed on the grid, and it was confirmed that the observed particles had a particle size similar to that of the particles observed with the confocal laser microscope. In the TEM image of the sample of Experimental Example 13, when the tip portion of the particle was enlarged and observed, it was confirmed that the titania nanosheets were laminated along the long axis direction of the rod-shaped particle. As estimated from the results of the small-angle/wide-angle X-ray scattering measurement, the titania nanosheets formed the nanosheet laminated nanofibers, and the structure of an aggregate was formed in which the nanosheet laminated nanofibers thus formed were further aggregated.

### (AFM Observation Results)

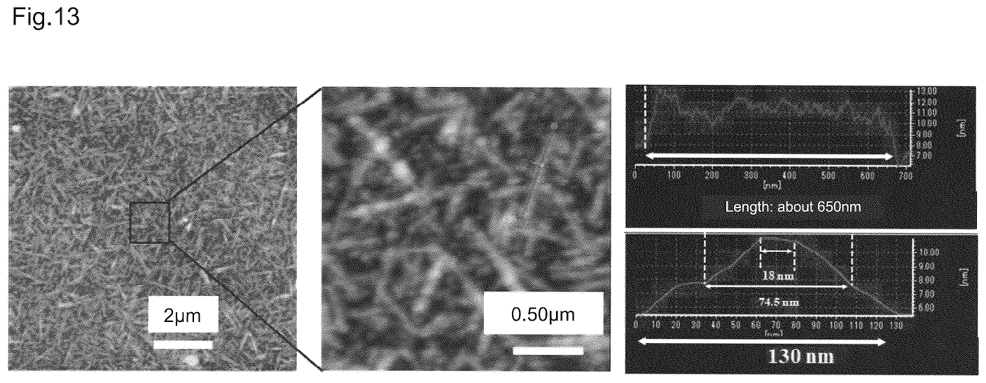

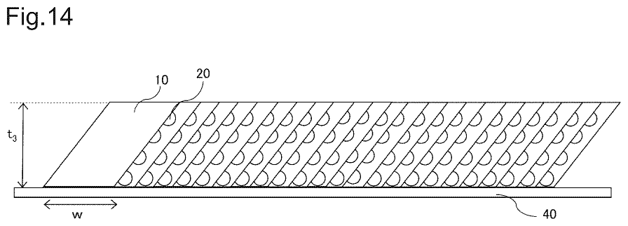

FIG. 13 illustrates the results of the AFM observation of the sample according to Experimental Example 2. FIG. 14 illustrates an outline of estimated nanosheet laminated nanofibers.

A sample obtained by diluting the sample of Experimental Example 2 (equivalent ratio: 0.20 times equivalent) 50 times was observed. The concentration of [Ru(bpy)₃]²⁺ of this sample is 0.000078 M, the TMA⁺ concentration is 0.00137 M, and the titania nanosheet concentration is 0.00110 wt %. In the AFM observation, the diluted sample was cast on a mica plate, and the sample dried for one day was observed. As a result, as illustrated in FIG. 13, an elongated structure having a thickness t3 of about 12 to 13 nm, a width w of about 18 nm, and a length 1 of 650 nm was observed. Since the particle size of the titania nanosheet obtained by preparation is about 12 nm, it is considered that a laminated column formed of the titania nanosheets and the ruthenium complexes has been produced. Specifically, it is considered that, on a mica plate 40 as illustrated in FIG. 14, titania nanosheets 10 were laminated with ruthenium complexes ([Ru(bpy)₃]²⁺) 20 interposed therebetween, thereby forming nanosheet laminated nanofibers.

### Study of Rinsing of Sample

From the observation results of the sample according to Experimental Example 9 (equivalent ratio: 1.0 time equivalent) and the sample according to Experimental Example 11 (equivalent ratio: 2.0 times equivalent) by the visual observation, it is considered that the tendency of separation into a supernatant and a precipitate is stronger as the [Ru(bpy)₃]²⁺ concentration is higher. This is presumed to be because the nanosheet laminated nanofibers accumulated and precipitated, and the supernatant contained a salt or the like that did not form nanosheet laminated nanofibers. Therefore, the inventors attempted to rinse the sample according to Experimental Example 9 using separation.

The concentration of [Ru(bpy)₃]²⁺, the concentration of mNS, and the concentration of TMA⁺ contained in the sample according to Experimental Example 9 after rinsed twice (hereinafter referred to as “rinsed sample”) were calculated as follows. First, the rinsed sample was diluted 7,000 times to prepare 50 mL, and the absorbance was measured using UV-vis. As a result, the concentration of [Ru(bpy)₃]²⁺ in the prepared rinsed sample was 1.1×10⁻² (mol/L), and the mNS concentration was 0.16 (wt %). Thus, it was revealed that, as compared with immediately after preparing [Ru(bpy)₃]²⁺-mNS (first sample), the concentration of [Ru(bpy)₃]²⁺ was decreased by 8×10⁻³ (mol/L) and the mNS concentration was decreased by 0.94 (wt %). Since the absorption spectrum of TMA⁺ was not confirmed, the concentration of TMA⁺ was calculated from the mass of the rinsed sample. The TMA⁺ concentration was calculated to be 0.0409 (mol/L) and estimated to be decreased by 0.10 (mol/L).

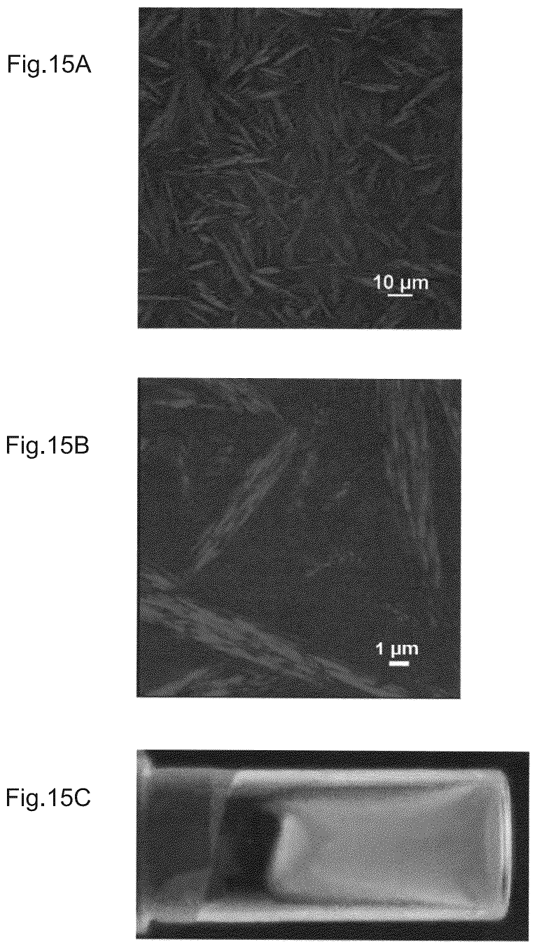

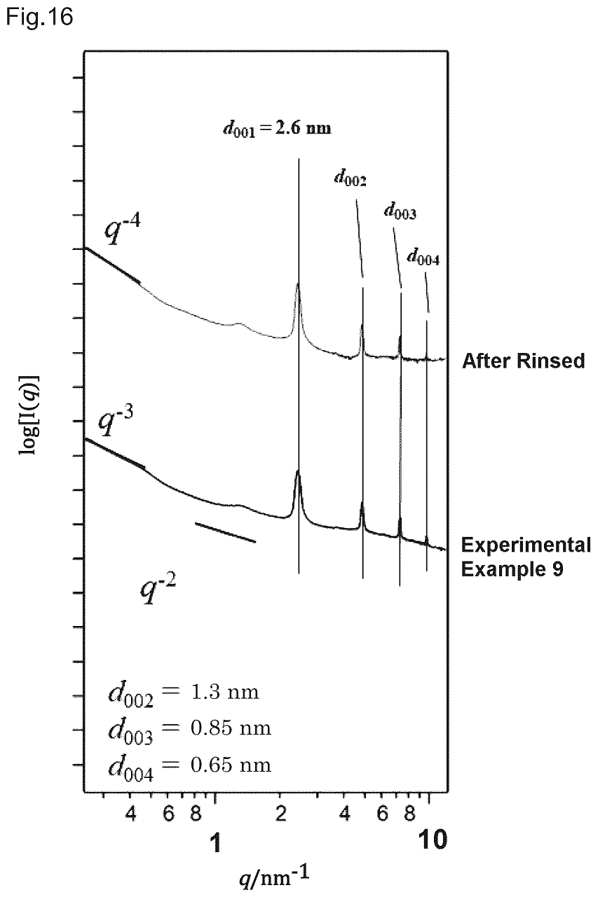

FIGS. 15A to 15C illustrate the observation results of the rinsed sample. Specifically, FIG. 15A and FIG. 15B illustrate CLSM images with different magnifications, and FIG. 15C illustrates the result of visually observation of the sample in a vial using the crossed Nicols. FIG. 16 illustrates the results of the small-angle/wide-angle X-ray scattering measurement of the samples of Experimental Example 9 (upper one is a sample after rinsed and lower one is a sample before rinsed).

Then, when the rinsed sample was observed by the crossed Nicols observation, birefringence was observed (FIG. 15C). In addition, in the CLSM observation, aggregates of elongated nanosheet laminated nanofibers were observed (FIG. 15B).

The WAXS measurement was performed on each of the sample according to Experimental Example 9 (sample before rinsed) and the sample according to Experimental Example 9 rinsed twice (FIG. 16). As a result, in the rinsed sample, peaks corresponding to interlayer distances of 2.6 nm, 1.3 nm, 0.85 nm, and 0.65 nm were observed. On the small-angle side, the slope of q⁻⁴ indicating the presence of a spherical structure was confirmed. From these results, it was confirmed that, even after rinsed, the sample maintained a laminated structure similar to that of the sample before rinsed.

From the above, it was revealed that the inorganic nanosheet composite ([Ru(bpy)₃]²⁺-mNS) in which a ruthenium complex was located between titania nanosheets in nanosheet laminated nanofibers, in which the plurality of titania nanosheets were laminated, was able to be prepared by controlling the equivalent ratio of the ruthenium complex to the ion exchange capacity of the titania nanosheet. It was also revealed that the structure of the composite changed from nanosheet laminated nanofibers to an aggregate of nanosheet laminated nanofibers as the equivalent ratio increased. Specifically, in the experimental examples, it was revealed that, by setting [Ru(bpy)₃]²⁺/CEC (equivalent ratio) to 0.20 times equivalent or more, formation of nanosheet laminated nanofibers began, by controlling the equivalent ratio to 0.80 times equivalent or more, nanosheet laminated nanofibers were reliably formed, and by setting the equivalent ratio to 1.0 time equivalent or more, an aggregate of nanosheet laminated nanofibers was formed.

That is, it was revealed that: when [Ru(bpy)₃]²⁺/CEC (equivalent ratio) was from 0.0 times equivalent to 0.10 times equivalent, an isotropic phase of the solution of titania nanosheets or the mixed solution of titania nanosheets and ruthenium complexes was formed; when the equivalent ratio was from 0.20 times equivalent to 0.60 times equivalent, nanosheet laminated nanofibers were formed; when the equivalent ratio was from 0.70 times equivalent to 0.90 times equivalent, birefringence was observed as the nanosheet laminated nanofibers increased; when the equivalent ratio was 1.0 time equivalent or more, laminated columns and aggregates of the laminated columns were formed; and when the equivalent ratio was 2.0 times equivalent, aggregates of the laminated columns were formed dominantly. Therefore, it was revealed that the structure of the inorganic nanosheet composite was able to be controlled by controlling the equivalent ratio.

In a case where no cationic species was added to the colloidal solution of the monodisperse inorganic nanosheets used in the experimental examples (when only TMA was used), the string-like structure of the monodisperse inorganic nanosheets could be formed when the concentration of TMA⁺ in the colloidal solution was about 1.5 M to 2.0 M, but the structure collapsed (the structure dissolved and disappeared) when the concentration was less than 1.5 M. In contrast, as represented in the experimental examples, in a case where a predetermined cationic species was used, the lamination peak of the inorganic nanosheets and the like were observed even when the concentration of TMA⁺ was 10⁻² M at the most, and it was confirmed that the inorganic nanosheets existed as nanosheet laminated nanofibers. In addition, since TMA is a strong alkali, desalting treatment is preferably performed when the inorganic nanosheet composites obtained in the experimental examples are applied to various materials.

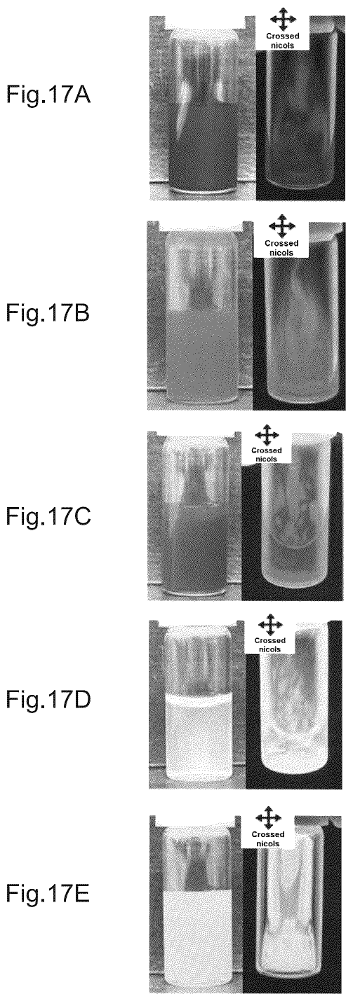

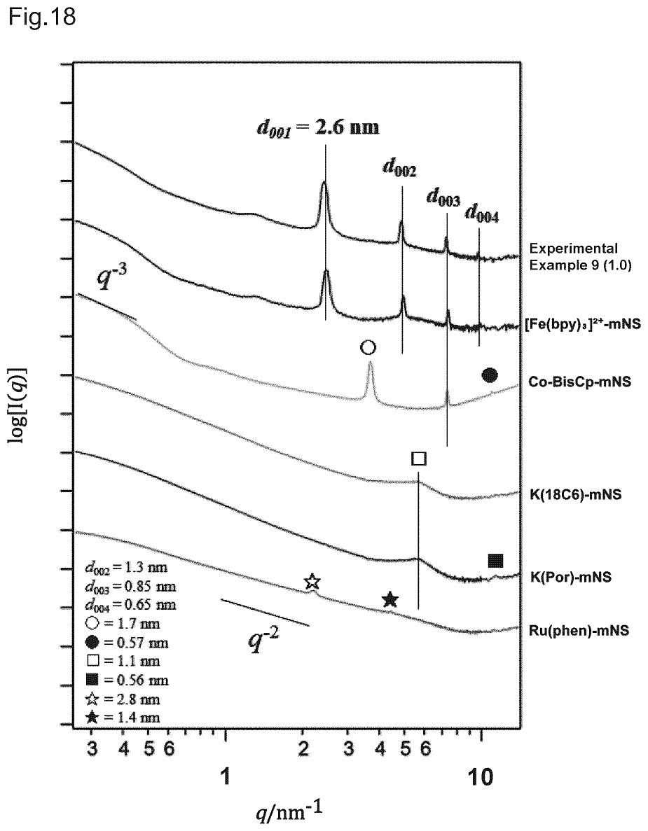

FIGS. 17A to 17E illustrate the results of the visual observation and the crossed Nicols observation of the inorganic nanosheet composites obtained by combining titania nanosheets (mNS) with each of an iron trisbipyridine complex (Fe(bpy)₃²⁺), a ruthenium trisphenanthrin complex (Ru(phen)₃²⁺), potassium porphyrin (K(Por)), potassium enveloped crown ether (K(18C6)), and cobaltocene (Co-Cp2). FIG. 18 illustrates the results of the SAXS/WAXS measurement of laminated nanofibers of an inorganic nanosheet composite in which various metal complexes and titania nanosheets (mNS) are combined, with the results of Experimental Example 9, in a comparison manner.

Specifically, FIG. 17A illustrates the observation results of an inorganic nanosheet composite prepared in the same manner as in Experimental Example 8 using Fe(bpy)₃²⁺. The left side in FIG. 17A is the result of the visual observation, and the right side is the result of the crossed Nicols observation. FIG. 17B illustrates the observation results of the inorganic nanosheet composite prepared in the same manner as in Experimental Example 8 using Ru(phen)₃²⁺. The left side in FIG. 17B is the result of the visual observation, and the right side is the result of the crossed Nicols observation. FIG. 17C illustrates the observation results of the inorganic nanosheet composite prepared in the same manner as in Experimental Example 8 using K(Por). The left side in FIG. 17C is the result of the visual observation, and the right side is the result of the crossed Nicols observation. FIG. 17D illustrates the observation results of the inorganic nanosheet composite prepared in the same manner as in Experimental Example 8 using K (18C6). The left side in FIG. 17D is the result of the visual observation, and the right side is the result of the crossed Nicols observation. FIG. 17E illustrates the observation results of the inorganic nanosheet composite prepared in the same manner as in Experimental Example 8 using Co-Cp2. The left side in FIG. 17E is the result of the visual observation, and the right side is the result of the crossed Nicols observation.

In any of the samples, as in Experimental Example 8 and the like, no visible particles were observed, and thus it was revealed that the inorganic nanosheets were not randomly aggregated. Furthermore, similarly to Experimental Example 8 and the like, since the flow birefringence index was observed in the result of the crossed Nicols observation, it was inferred that nanofibers or nanofiber bundles were formed. In addition, according to the result of the SAXS measurement (FIG. 18), in the sample prepared using [Fe(bpy)₃]²⁺, a peak almost similar to that in the case of [Ru(bpy)₃]²⁺ was observed, and it was confirmed that a laminated structure of nanosheets in which [Fe(bpy)₃]²⁺ was inserted between the layers was formed. In the sample prepared using Ru(phen)₃²⁺, peaks at d values of 2.84 nm and 1.42 nm appeared, and the structure was identified as a structure in which hydrated Ru(phen)₃²⁺ and mNS were alternately laminated. When taking into account that the molecular size of Ru(phen)₃²⁺ is larger than that of [Ru(bpy)₃]²⁺, it is reasonable that the lamination interval is slightly larger than that of the system of [Ru(bpy)₃]²⁺. With K(Por) and K (18C6), a peak having a d value of 1.2 nm was observed. K(Por) and K (18C6) have a planar molecular structure, and the thickness of the molecule can be considered to be equivalent to about 0.3 nm, which is the ion diameter of K ions, or about 0.5 nm, which is the diameter of the hydrated ion thereof. Therefore, in consideration of the nanosheet thickness of 0.65 nm, the interlayer distance of 1.2 nm is considered to mean that a laminated structure was formed in which K(Por) or K (18C6) was inserted between the layers of mNSs such that the molecular plane of K(Por) or K (18C6) and the nanosheet were parallel to each other. In the nanofibers into which tetramethylammonium was inserted before these substances were introduced, the d value was 1.7 nm, and the d value greatly changed in any system, indicating that these molecules replaced tetramethylammonium and were incorporated into the laminated structure in the nanofibers. With Co-Cp2, a peak having a d value of 1.7 nm was observed. The value is similar to the d value of the nanofiber into which tetramethylammonium is inserted, but is a reasonable value when taking into account the molecular size of Co-Cp2.

Each cationic species was prepared as follows.

### (Preparation of Iron Trisbipyridine Complex Aqueous Solution)

First, 0.117 g of iron (II) chloride tetrahydrate, 0.275 g of 2,2′-bipyridyl and 49.7 g of water were mixed, and then refluxed at 80° C. for 24 hours under the air atmosphere. In this way, a [Fe(bpy)₃]²⁺) complex aqueous solution of 0.0117 mol/L iron (II) chloride tetrahydrate and 0.0350 mol/L 2,2′-bipyridyl was prepared.

### (Ruthenium Dichlorotrisphenyl Complex Aqueous Solution)

First, 0.574 g of dichlorotris(1,10-phenanthroline) ruthenium (II) hydrate and 19.4 g of water were mixed, and then stirred at 500 rpm for 60 minutes to prepare 20.0 mL of a 0.03914 mol/L [Ru(phen)₃]²⁺ aqueous solution.

### (Preparation of Potassium Porphyrin Complex Aqueous Solution)

First, 9.48 g of a 0.273 M TMAOH aqueous solution and 0.0200 g of 5,10,15,20-tetrakis (4-hydroxyphenyl) porphyrin were mixed, and then the mixture was stirred until it was dissolved, thereby preparing 10 mL of a potassium porphyrin complex aqueous solution (0.671 mol/L potassium chloride and 0.00295 mol/L crown ether).

### (Preparation of Potassium Crown Ether Complex Aqueous Solution)

First, 1.50 g of crown ether, 1.50 g of KCl, and 8.50 g of water were mixed, and then the mixture was stirred until it was dissolved, thereby preparing 10 mL of a potassium crown ether complex aqueous solution (1.75 mol/L potassium chloride and 0.493 mol/L crown ether).

### (Preparation of Cobaltocene Complex Aqueous Solution)

First, 0.0858 g of bis(cyclopentadienyl) cobalt (III) hexafluorophosphate cobaltocene hexafluorophosphate and 9.91 g of N, N-dimethylformamide (DMF) were mixed, and then the mixture was stirred for 10 minutes to prepare 10 mL of a cobaltocene DMF aqueous solution.

The following reagents (metal complexes) were used.
[Ru(phen)₃]²⁺: Dichlorotris(1,10-phenanthroline) ruthenium (II) monohydrate (manufactured by Tokyo Chemical Industry Co., Ltd.)
Iron complex: iron (II) chloride tetrahydrate (FeCl₂₄H₂O) (manufactured by FUJIFILM Wako Pure Chemical Corporation), 2,2′-bipyridyl (manufactured by Tokyo Chemical Industry Co., Ltd.)
Potassium porphyrin complex: potassium chloride (KCl) (manufactured by FUJIFILM Wako Pure Chemical Corporation), 5, 10, 15, 20-tetrakis (4-hydroxyphenyl) porphyrin (manufactured by Tokyo Chemical Industry Co., Ltd.)
Potassium crown ether type: potassium chloride (KCl) (manufactured by FUJIFILM Wako Pure Chemical Corporation), 18-crown 6-ether (manufactured by Tokyo Chemical Industry Co., Ltd.)
Cobaltocene complex:
   bis(cyclopentadienyl) cobalt (III) hexafluorophosphate cobaltocene hexafluorophosphate (manufactured by Tokyo Chemical Industry Co., Ltd.), N, N-dimethylformamide (manufactured by FUJIFILM Wako Pure Chemical Corporation)

Characteristics of these samples include that, for example, the inorganic nanosheets are not aggregated (not randomly aggregated) and flow birefringence or stationary birefringence is observed. The fact that flow birefringence or stationary birefringence is observed is a feature indicating that nanofibers are formed.

The embodiments and experimental examples of the present invention have been described above, and the embodiments and experimental examples described above do not limit the invention according to the claims. In addition, it should be noted that not all combinations of features described in the embodiments and experimental examples are essential for means for solving the problems to be solved by the invention.

The inorganic nanosheet composite and the method for producing an inorganic nanosheet composite according to the present embodiment can also be mentioned in the following supplementary notes that should not be confused with the claims.

### (Note 1)

An inorganic nanosheet composite including:
a plurality of monodisperse inorganic nanosheets; and
a cationic species (for example, a metal complex, a metal cluster ion, a molecular ion, or a polymer electrolyte) located between the plurality of monodisperse inorganic nanosheets, wherein
an equivalent ratio of the cationic species to an ion exchange capacity of the monodisperse inorganic nanosheet is an equivalent ratio in a range in which a nanosheet laminated nanofiber in which the plurality of monodisperse inorganic nanosheets are laminated is formed.

What is claimed is:

1. An inorganic nanosheet composite comprising:
a plurality of monodisperse inorganic nanosheets; and
a cationic species excluding a simple metal ion and an ammonium cation, wherein
the cationic species is located between the monodisperse inorganic nanosheets in a nanosheet laminated nanofiber in which the plurality of monodisperse inorganic nanosheets are laminated, and
an equivalent ratio of the cationic species to an ion exchange capacity of the monodisperse inorganic nanosheet is an equivalent ratio in a range in which the nanosheet laminated nanofiber is formed.

2. The inorganic nanosheet composite according to claim 1, wherein when the equivalent ratio is equal to or more than a predetermined equivalent ratio, an aggregate of the nanosheet laminated nanofibers is included.

3. The inorganic nanosheet composite according to claim 1, wherein
the monodisperse inorganic nanosheet is selected from the group consisting of a layered metal chalcogenide, a layered metal oxide, a layered metal oxyhalide, a layered metal phosphate, a clay mineral or a layered silicate, and a layered double hydroxide, and
the cationic species is selected from the group consisting of a metal complex, a metal cluster ion, a molecular ion, and a polymer electrolyte.

4. The inorganic nanosheet composite according to claim 1, wherein the inorganic nanosheet composite is an inorganic nanosheet composite for a visible light responsive photocatalyst.

5. A method for producing an inorganic nanosheet composite, the method comprising:
mixing an ammonium salt, a metal alkoxide, and a solvent to prepare a mixed solution;
preparing a colloidal solution of monodisperse inorganic nanosheets synthesized by refluxing the mixed solution; and
forming an inorganic nanosheet composite by mixing an aqueous solution including a cationic species excluding a simple metal ion and an ammonium cation with the colloidal solution, wherein
the cationic species is located between the respective monodisperse inorganic nanosheets in a nanosheet laminated nanofiber in which the plurality of monodisperse inorganic nanosheets are laminated, and
an equivalent ratio of the cationic species to an ion exchange capacity of the monodisperse inorganic nanosheet is an equivalent ratio in a range in which the nanosheet laminated nanofiber is formed.
